(19) United States
(12) Patent Application Publication
(10) Pub. No.: US 2019/0253477 A1
(43) Pub. Date: Aug. 15, 2019

(54) Data Fragment Recombination for Internet of Things Devices

(71) Applicant: INTEL CORPORATION, Santa Clara, CA (US)

(72) Inventors: Keith Nolan, Mullingar (IE); Mark Kelly, Leixlip (IE); Michael Nolan, Maynooth (IE); Pat Cheevers, Dublin (IE)

(73) Assignee: INTEL CORPORATION, Santa Clara, CA (US)

(21) Appl. No.: 15/942,400

(22) Filed: Mar. 30, 2018

(51) Int. Cl. H04L 29/08; H04L 12/801

(52) U.S. Cl. CPC H04L 67/06; H04L 47/34

(57) ABSTRACT

In some examples, an Internet of Things (IoT) device to recombine data fragments of a data payload. The IoT device includes storage to store instructions and a processor. The processor is to execute the stored instructions to receive the data fragments in order or out of order, to determine whether all data fragments of the data payload have been received, and if all data fragments of the data payload have been received, to store the data fragments in order.

### TECHNICAL FIELD

The present techniques relate generally to Internet of Things (IoT) devices, including, for example, IoT devices that can perform remote sensing and actuation functions. More specifically, present techniques relate to data recombination that can be implemented for IoT devices.

### BACKGROUND

A current view of the Internet is the connection of clients, such as personal computers, tablets, smart phones, servers, digital photo-frames, and many other types of devices, to publicly-accessible data-centers hosted in server farms. However, this view represents a small portion of the overall usage of the globally-connected network. A very large number of connected resources currently exist, but are not publicly accessible. Examples include corporate networks, private organizational control networks, and monitoring networks spanning the globe, often using peer-to-peer relays for anonymity.

It has been estimated that the Internet of Things (IoT) may bring Internet connectivity to more than 15 billion devices by 2020. For organizations, IoT devices may provide opportunities for monitoring, tracking, or controlling other devices and items, including further IoT devices, other home and industrial devices, items in manufacturing and food production chains, and the like. The emergence of IoT networks has served as a catalyst for profound change in the evolution of the Internet. In the future, the Internet is likely to evolve from a primarily human-oriented utility to an infrastructure where humans may eventually be minority actors in an interconnected world of devices.

In this view, the Internet will become a communications system for devices, and networks of devices, to not only communicate with data centers, but with each other. The devices may form functional networks, or virtual devices, to perform functions, which may dissolve once the function is performed. Challenges exist in enabling reliable, secure, and identifiable devices that can form networks as needed to accomplish tasks.

### BRIEF DESCRIPTION OF THE DRAWINGS

FIG. 1 illustrates interconnections that may be present in the Internet in accordance with some embodiments.

FIG. 2 illustrates a network topology for a number of Internet of Things (IoT) networks coupled through backbone links to gateways in accordance with some embodiments.

FIG. 3 illustrates a cloud computing network, or cloud, in communication with a number of IoT devices in accordance with some embodiments.

FIG. 4 illustrates a cloud computing network, or cloud, in communication with a mesh network of IoT devices, which may be termed a fog device, operating at the edge of the cloud in accordance with some embodiments.

FIG. 5 illustrates a system in accordance with some embodiments.

FIG. 6 illustrates data fragmentation and data recombination in accordance with some embodiments.

FIG. 7 illustrates data fragmentation and data recombination in accordance with some embodiments.

FIG. 8 illustrates data recombination in accordance with some embodiments.

FIG. 9 illustrates data recombination in accordance with some embodiments.

FIG. 10 illustrates data recombination in accordance with some embodiments.

FIG. 11 illustrates data recombination in accordance with some embodiments.

FIG. 12 illustrates a partial image data sequence diagram in accordance with some embodiments.

FIG. 13 is a block diagram of an example of components that may be present in an IoT device for implementing data fragmentation and/or data recombination in accordance with some embodiments.

FIG. 14 is a block diagram of a medium or media such as one or more non-transitory, machine readable medium including code to direct a processor to implement data fragmentation and/or data recombination in accordance with some embodiments.

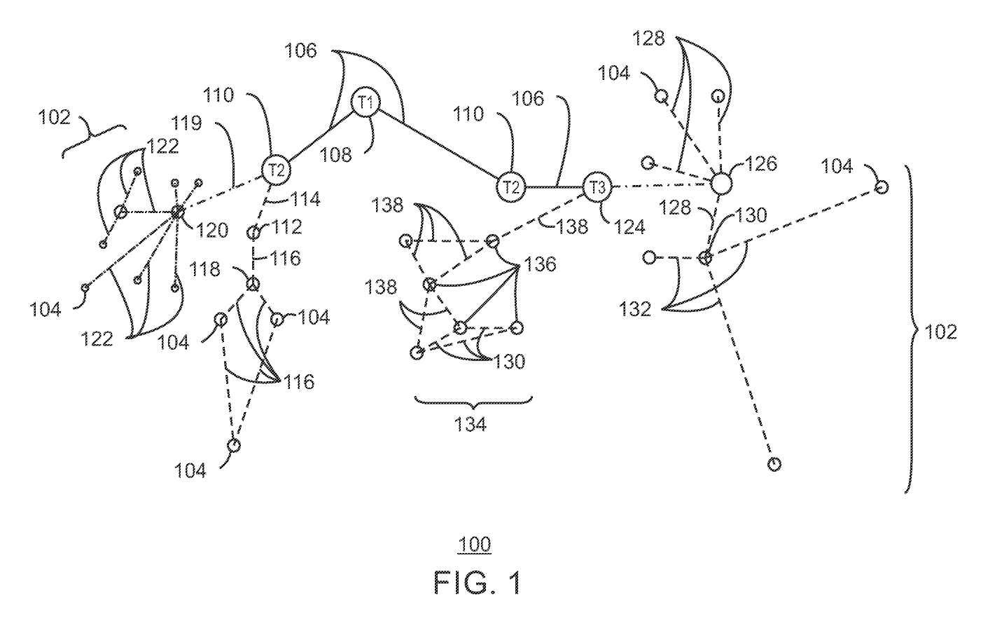

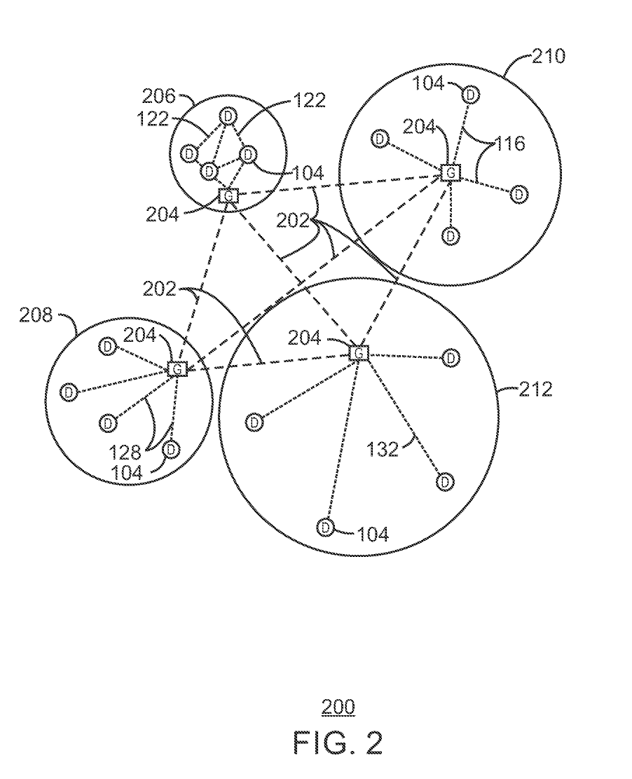

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In some embodiments, data fragmentation and/or data recombination is implemented. For example, in some embodiments, data fragmentation and/or data recombination in Internet of Things (IoT) networks is implemented (for example, data fragmentation and/or data recombination in IoT networks such as fog networks or edge networks). Some embodiments relate to data fragment recombination.

Some embodiments relate to transmitting fragmented files over a complex network. Some networks (for example, some IoT networks) are designed to transmit large files over long distances (for example, via wireless transmission devices). Such wireless transmission devices may be volatile and may support a large amount of data (for example, such as image or video files). In some embodiments, these large data files can be fragmented and transmitted in fragments over a complex network. For example, in some embodiments, the data files can be transmitted over a complex network that may include multiple links.

Some embodiments relate to reconstitution of the fragmented files, for example, including dealing with failures, retries, repetitions, and/or other real world issues that affect the quality of the data fragmentation and recombination process. In some embodiments, the process can be implemented in a wireless protocol agnostic manner, and can be implemented across multiple different wireless protocols including constrained wireless protocols (for example, supporting tens to hundreds of bytes per second, and/or over long distances such as, for example, 15 or more kilometers).

Some embodiments can be implemented with extremely large files over medium or high bandwidth connections, for example, where a large file is split up into a number of parts (or fragments) that are transmitted one at a time over the network. The fragmentation and recombination of the fragments are not tied to a particular file type or file size, and can be implemented with any data file type according to some embodiments. For example, embodiments can be implemented with large data files over fast connections. In some embodiments, for example, data fragmentation and recombination could be implemented over a fast connection (for example, a 10 gigabit connection) with large file sizes (for example, a terabyte file size), and data could be fragmented into big chunks (for example, 100s of gigabyte size fragments).

Some embodiments are system agnostic. For example, some embodiments can be related to data fragmentation and transmission over a variety of networks, including IoT networks of IoT devices, wired networks and/or wireless networks. For example, some embodiments can be implemented for fragments transmitted using LoRaWAN™ (Long Range Wide Area Network), WiFi, Ethernet, cellular, or other transmission protocols, including any combination thereof. Some embodiments are wired and/or wireless protocol agnostic.

FIGS. 1-5 include example operating environments such as Internet of Things (IoT) environments which may utilize principles described herein. The example operating environments of FIGS. 1-5 may utilize principles of data fragmentation and/or data recombination as described herein and illustrated in the accompanying drawings (for example, data fragmentation and/or data recombination for fog networks, edge networks, foglets, etc.)

The Internet of Things (IoT) is a system in which a large number of computing devices are interconnected to each other and to a communications network (e.g., the Internet) to provide a functionality, such as data acquisition and actuation, at very low levels in networks. Low levels indicate devices that may be located at or near the edges of networks, such as the last devices before the networks end. As used herein, an IoT device may include a device performing a function, such as sensing or control, among others, in communication with other IoT devices and a communications network. The IoT device may include an autonomous device or a semiautonomous device configured to perform one or more functions. Often, IoT devices can be limited in memory, size, or functionality, allowing larger numbers to be deployed for a similar cost to a smaller number of larger devices. However, an IoT device may be a smart phone, laptop, tablet, PC, and/or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home devices, such as water distribution systems, electric power distribution systems, pipeline control systems, plant control systems, light switches, thermostats, locks, cameras, alarms, motion sensors, and the like, among others. The IoT devices may be accessible through a controller, such as computers, servers, and other systems, for example, to control systems or access data. The controller and the IoT devices can be remotely located from one another.

The Internet can be configured to provide communications to a large number of IoT devices. Accordingly, as described herein, a number of innovations for the future Internet are designed to address the need for network layers, from central servers, through gateways, down to edge devices, to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software. The services may be provided in accordance with the Quality of Service (QoS) terms specified in service level and service delivery agreements. The use of IoT devices and networks present a number of new challenges in a heterogeneous network of connectivity including a combination of wired and wireless technologies as depicted, for example, in FIGS. 1 and 2.

FIG. 1 is a drawing of interconnections that may be present between the Internet 100 and IoT networks in accordance with some embodiments. The interconnections may couple smaller networks 102, down to the individual IoT device 104, to the backbone 106 of the Internet 100. To simplify the drawing, not every device 104, or other object, is labeled.

In FIG. 1, top-level providers, which may be termed tier 1 (“T1”) providers 108, are coupled by the backbone 106 of the Internet to other providers, such as secondary or tier 2 (“T2”) providers 110. In some aspects, the backbone 106 can include optical fiber links. In one example, a T2 provider 110 may couple to a tower 112 of an LTE cellular network, for example, by further links, by microwave communications 114, or by other communications technologies. The tower 112 may couple to a mesh network including IoT devices 104 through an LTE communication link 116, for example, through a central node 118. The communications between the individual IoT devices 104 may also be based on LTE communication links 116.

In another example, a high-speed uplink 119 may couple a T2 provider 110 to a gateway 120. A number of IoT devices 104 may communicate with the gateway 120, and with each other through the gateway 120, for example, over Bluetooth low energy (BLE) links 122.

The backbone 106 may couple lower levels of service providers to the Internet, such as tier 3 (“T3”) providers 124. A T3 provider 124 may be considered a general Internet service provider (ISP), for example, purchasing access to the backbone 106 from a T2 provider 110 and providing access to a corporate gateway 126 and other customers.

From the corporate gateway 126, a wireless local area network (WLAN) can be used to communicate with IoT devices 104 through Wi-Fi® links 128. A Wi-Fi link 128 may also be used to couple to a low power wide area (LPWA) gateway 130, which can communicate with IoT devices 104 over LPWA links 132, for example, compatible with the LoRaWAN™ (Long Range Wide Area Network) specification promulgated by the LoRa Alliance.

The T3 provider 124 may also provide access to a mesh network 134 through a coordinator device 136 that communicates with the T3 provider 124 using any number of communications links, such as an LTE cellular link, an LPWA link, or a link 138 based on the IEEE 802.15.4 standard, such as Zigbee®. Other coordinator devices 136 may provide a chain of links that forms one or more cluster tree of linked devices.

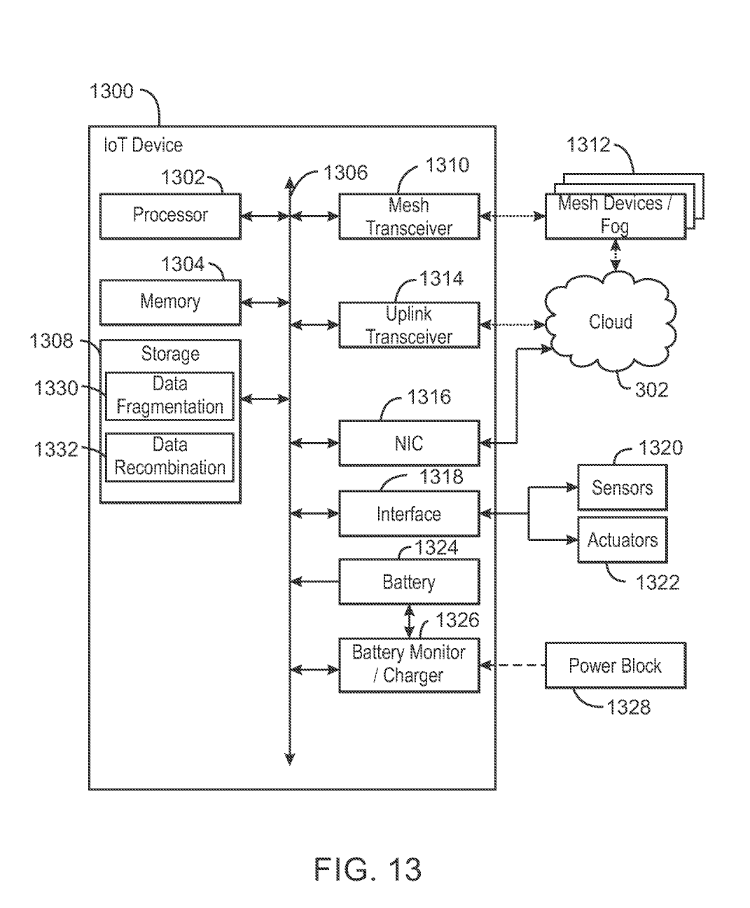

In some aspects, one or more IoT devices 104 include the appropriate transceiver for the communications with other devices. Further, one or more IoT devices 104 may include other radio, optical, or acoustic transceivers, as well as wired network interfaces, for communications using additional protocols and frequencies. In some aspects, one or more IoT devices 104 includes components described in regard to FIG. 13.

The technologies and networks may enable the growth of devices and networks. As the technologies grow, the network may be developed for self-management, functional evolution, and/or collaboration, without needing direct human intervention. Thus, the technologies may enable networks to function without centralized controlled systems. The technologies described herein may automate the network management and operation functions beyond current capabilities. Further, the approaches may provide the flexibility to have a centralized control operating without human intervention, a centralized control that is automated, or any combinations thereof.

FIG. 2 is a drawing of a network topology 200 that may be used for a number of Internet of Things (IoT) networks coupled through backbone links 202 to gateways 204 in accordance with some embodiments. Like numbered items are as described with respect to FIG. 1. Further, to simplify the drawing, not every device 104, or communications link 116, 122, 128, or 132 is labeled. The backbone links 202 may include any number of wired or wireless technologies, and may be part of a local area network (LAN), a wide area network (WAN), or the Internet.

Although the topologies in FIG. 2 are hub-and-spoke and the topologies in FIG. 1 are peer-to-peer, it may be observed that these are not in conflict, but that peer-to-peer nodes may behave as hub-and-spoke through gateways. It may also be observed in FIG. 2 that a sub-net topology may have multiple gateways, rendering it a hybrid topology rather than a purely hub-and-spoke topology (or rather than a strictly hub-and-spoke topology).

The network topology 200 may include any number of types of IoT networks, such as a mesh network 206 using Bluetooth Low Energy (BLE) links 122. Other IoT networks that may be present include a WLAN network 208, a cellular network 210, and an LPWA network 212. Each of these IoT networks may provide opportunities for new developments, as described herein.

For example, communications between IoT devices 104, such as over the backbone links 202, may be protected by a decentralized system for authentication, authorization, and accounting (AAA). In a decentralized AAA system, distributed payment, credit, audit, authorization, brokering, arbitration, and authentication systems may be implemented across interconnected heterogeneous infrastructure. This allows systems and networks to move towards autonomous operations.

In these types of autonomous operations, machines may contract for human resources and negotiate partnerships with other machine networks. This may allow the achievement of mutual objectives and balanced service delivery against outlined, planned service level agreements as well as achieve solutions that provide metering, measurements and traceability and trackability. The creation of new supply chain structures and methods may enable a multitude of services to be created, mined for value, and collapsed without any human involvement.

The IoT networks may be further enhanced by the integration of sensing technologies, such as sound, light, electronic traffic, facial and pattern recognition, smell, and vibration, into the autonomous organizations. The integration of sensory systems may allow systematic and autonomous communication and coordination of service delivery against contractual service objectives, orchestration and quality of service (QoS) based swarming and fusion of resources.

The mesh network 206 may be enhanced by systems that perform inline data-to-information transforms. For example, self-forming chains of processing resources comprising a multi-link network may distribute the transformation of raw data to information in an efficient manner. This may allow such functionality as a first stage performing a first numerical operation, before passing the result to another stage, the next stage then performing another numerical operation, and passing that result on to another stage. The system may provide the ability to differentiate between assets and resources and the associated management of each. Furthermore, the proper components of infrastructure and resource based trust and service indices may be inserted to improve the data integrity, quality assurance, and deliver a metric of data confidence.

As described herein, the WLAN network 208 may use systems that perform standards conversion to provide multi-standard connectivity, enabling IoT devices 104 using different protocols to communicate. Further systems may provide seamless interconnectivity across a multi-standard infrastructure comprising visible Internet resources and hidden Internet resources.

Communications in the cellular network 210 may be enhanced by systems that offload data, extend communications to more remote devices, or both. The LPWA network 212 may include systems that perform non-Internet protocol (IP) to IP interconnections, addressing, and routing.

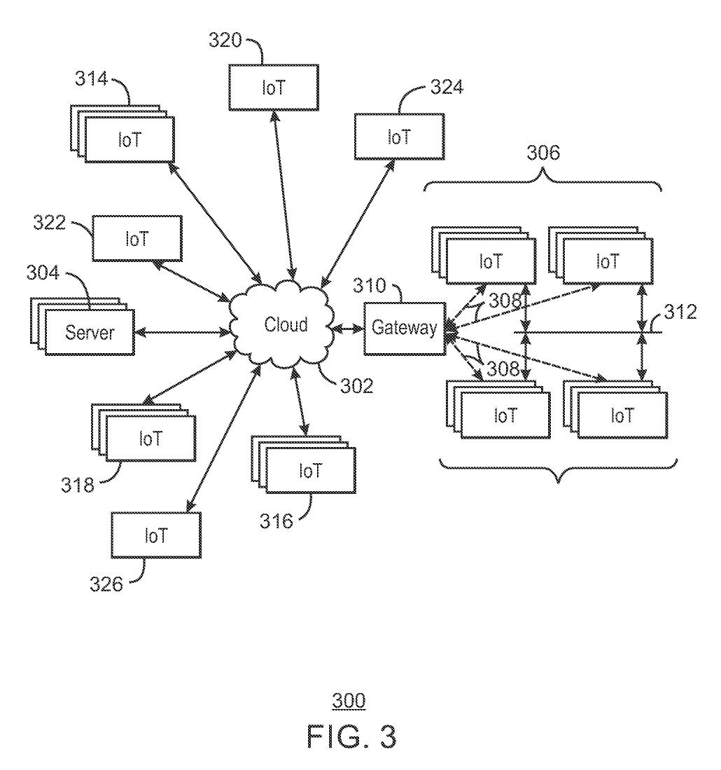

FIG. 3 is a drawing 300 of a cloud computing network, or cloud 302, in communication with a number of Internet of Things (IoT) devices in accordance with some embodiments. The cloud 302 may represent the Internet, or may be a local area network (LAN), or a wide area network (WAN), such as a proprietary network for a company. The IoT devices may include any number of different types of devices, grouped in various combinations. For example, a traffic control group 306 may include IoT devices along streets in a city. These IoT devices may include stoplights, traffic flow monitors, cameras, weather sensors, and the like. The traffic control group 306, or other subgroups, may be in communication with the cloud 302 through wireless links 308, such as LPWA links, and the like. Further, a wired or wireless sub-network 312 may allow the IoT devices to communicate with each other, such as through a local area network, a wireless local area network, and the like. The IoT devices may use another device, such as a gateway 310 to communicate with the cloud 302.

Other groups of IoT devices may include remote weather stations 314, local information terminals 316, alarm systems 318, automated teller machines 320, alarm panels 322, or moving vehicles, such as emergency vehicles 324 or other vehicles 326, among many others. Each of these IoT devices may be in communication with other IoT devices, with servers 304, or both.

As can be seen from FIG. 3, a large number of IoT devices may be communicating through the cloud 302. This may allow different IoT devices to request or provide information to other devices autonomously. For example, the traffic control group 306 may request a current weather forecast from a group of remote weather stations 314, which may provide the forecast without human intervention. Further, an emergency vehicle 324 may be alerted by an automated teller machine 320 that a burglary is in progress. As the emergency vehicle 324 proceeds towards the automated teller machine 320, it may access the traffic control group 306 to request clearance to the location, for example, by lights turning red to block cross traffic at an intersection in sufficient time for the emergency vehicle 324 to have unimpeded access to the intersection.

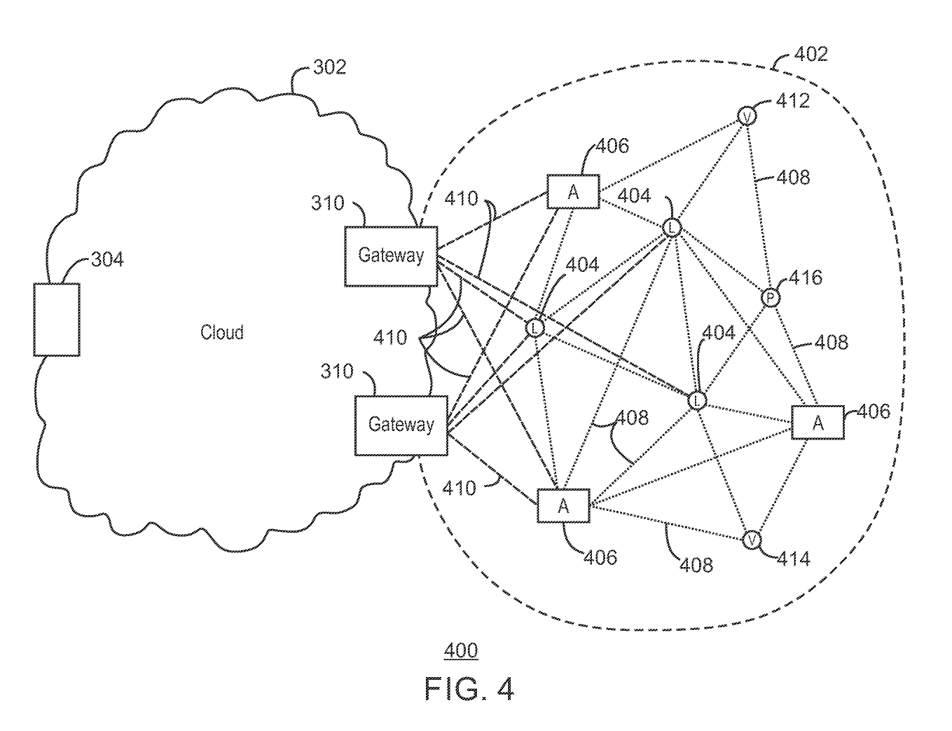

Clusters of IoT devices, such as the remote weather stations 314 or the traffic control group 306, may be equipped to communicate with other IoT devices as well as with the cloud 302. This may allow the IoT devices to form an ad-hoc network between the devices, allowing them to function as a single device, which may be termed a fog device. The fog device is discussed further with respect to FIG. 4.

FIG. 4 is a drawing 400 of a cloud computing network, or cloud 302, in communication with a mesh network of IoT devices, which may be termed a fog device 402, operating at the edge of the cloud 302 in accordance with some embodiments. Like numbered items are as described with respect to FIG. 3. As used herein, a fog device 402 is a cluster of devices that may be grouped to perform a specific function, such as traffic control, weather control, plant control, and the like.

In this example, the fog device 402 includes a group of IoT devices at a traffic intersection. The fog device 402 may be established in accordance with specifications released by the OpenFog Consortium (OFC), among others. These specifications allow the formation of a hierarchy of computing elements between the gateways 310 coupling the fog device 402 to the cloud 302 and to endpoint devices, such as traffic lights 404 and data aggregators 406 in this example. The fog device 402 can leverage the combined processing and network resources that the collective of IoT devices provides. Accordingly, a fog device 402 may be used for any number of applications including, for example, financial modeling, weather forecasting, seismic measurement, traffic analyses, security monitoring, and the like.

For example, traffic flow through the intersection may be controlled by a plurality of traffic lights 404 (e.g., three traffic lights 404). Analysis of the traffic flow and control schemes may be implemented by aggregators 406 that are in communication with the traffic lights 404 and each other through a mesh network. Data may be uploaded to the cloud 302, and commands received from the cloud 302, through gateways 310 that are in communication with the traffic lights 404 and the aggregators 406 through the mesh network.

Any number of communications links may be used in the fog device 402. Shorter-range links 408, for example, compatible with IEEE 802.15.4 may provide local communications between IoT devices that are proximate to the intersection. Longer-range links 410, for example, compatible with LPWA standards, may provide communications between the IoT devices and the gateways 310. To simplify the diagram, not every communication link 408 or 410 is labeled with a reference number.

The fog device 402 may be considered to be a massively interconnected network wherein a number of IoT devices are in communications with each other, for example, by the communication links 408 and 410. The network may be established using the open interconnect consortium (OIC) standard specification 1.0 released by the Open Connectivity Foundation™ (OCF) on Dec. 23, 2015. This standard allows devices to discover each other and establish communications for interconnects. Other interconnection and operability protocols may also be used, including, for example, the Open Platform Communications (OPC) Unified Architecture released in 2008 by the OPC Foundation, the AllJoyn protocol from the AllSeen alliance, the optimized link state routing (OLSR) Protocol, or the better approach to mobile ad-hoc networking (B.A.T.M.A.N.), among many others.

In some aspects, communications from one IoT device may be passed along the most convenient path to reach the gateways 310, for example, the path having the fewest number of intermediate hops, or the highest bandwidth, among others. In these networks, the number of interconnections provide substantial redundancy, allowing communications to be maintained, even with the loss of a number of IoT devices.

In some aspects, the fog device 402 can include temporary IoT devices. In other words, not all of the IoT devices may be permanent members of the fog device 402. For example, in the exemplary system 400, three transient IoT devices have joined the fog device 402, a first vehicle 412, a second vehicle 414, and a pedestrian 416. In these cases, the IoT device may be built into the vehicles 412 and 414, or may be an app on a smart phone carried by the pedestrian 416. Other IoT devices may also be present, such as IoT devices in bicycle computers, motorcycle computers, drones, and the like.

The fog device 402 formed from the IoT devices may be presented to clients in the cloud 302, such as the server 304, as a single device located at the edge of the cloud 302. In this example, the control communications to specific resources in the fog device 402 may occur without identifying any specific IoT device within the fog device 402. Accordingly, if one IoT device within the fog device 402 fails, other IoT devices in the fog device 402 may be able to discover and control a resource, such as an actuator, or other device attached to an IoT device. For example, the traffic lights 404 may be wired so as to allow any one of the traffic lights 404 to control lights for the other traffic lights 404. The aggregators 406 may also provide redundancy in the control of the traffic lights 404 and other functions of the fog device 402.

In some examples, the IoT devices may be configured using an imperative programming style, e.g., with each IoT device having a specific function and communication partners. However, the IoT devices forming the fog device 402 may be configured in a declarative programming style, allowing the IoT devices to reconfigure their operations and communications, such as to determine needed resources in response to conditions, queries, and device failures. This may be performed as transient IoT devices, such as the pedestrian 416, join the fog device 402.

As the pedestrian 416 is likely to travel more slowly than the vehicles 412 and 414, the fog device 402 may reconfigure itself to ensure that the pedestrian 416 has sufficient time to make it through the intersection. This may be performed by forming a temporary group of the vehicles 412 and 414 and the pedestrian 416 to control the traffic lights 404. If one or both of the vehicles 412 or 414 are autonomous, the temporary group may instruct the vehicles to slow down prior to the traffic lights 404. Further, if all of the vehicles at the intersection are autonomous, the need for traffic signals may be diminished since autonomous vehicles' collision avoidance systems may allow for highly inter-leaved traffic patterns that may be too complex for traffic lights to manage. However, traffic lights 404 may still be important for the pedestrian 416, cyclists, or non-autonomous vehicles.

As the transient devices 412, 414, and 416, leave the vicinity of the intersection of the fog device 402, the fog device 402 may reconfigure itself to eliminate those IoT devices from the network. As other transient IoT devices approach the intersection, the fog device 402 may reconfigure itself to include those devices.

The fog device 402 may include the traffic lights 404 for a number of intersections, such as along a street, along with all of the transient IoT devices along the street. The fog device 402 may then divide itself into functional units, such as the traffic lights 404 and other IoT devices proximate to a single intersection. This type of combination may enable the formation of larger IoT constructs, e.g., groups of IoT devices that perform a particular function, in the fog device 402.

For example, if an emergency vehicle joins the fog device 402, an emergency construct, or virtual device, may be created that includes all of the traffic lights 404 for the street, allowing control of the traffic flow patterns for the entire street. The emergency construct may instruct the traffic lights 404 along the street to stay red for opposing traffic and green for the emergency vehicle, expediting the passage of the emergency vehicle.

As illustrated by the fog device 402, the organic evolution of IoT networks is central to improving or maximizing the utility, availability and resiliency of IoT implementations. Further, the example indicates the usefulness of strategies for improving trust and therefore security. The local identification of devices may be important in implementations, as the decentralization of identity ensures a central authority cannot be exploited to allow impersonation of objects that may exist within the IoT networks. Further, local identification lowers communication overhead and latency.

Networks of devices may be provided in a multi-access edge computing (MEC) environment. Multi-access edge computing (MEC), also referred to as mobile edge computing, may offer application developers and content providers cloud-computing capabilities and an information technology service environment at the edge of a network. An MEC system may include an MEC orchestrator, and an MEC platform manager, which manage the provision of a service to a user equipment (UE) device, by a service provider, through one or more access points, or one or more MEC hosts.

The MEC environment may be part of a radio access network (RAN) that has been opened to third party providers, such as clearing houses for blockchain transactions. The RAN may provide a high bandwidth, low latency system that allows fog devices 402 to function more efficiently with applications and services in the cloud 302. Accordingly, MEC 302 may be seen as a cloud or fog server running at the edge of a mobile network and performing tasks that may not be achieved with traditional network infrastructure. Machine-to-Machine gateway and control functions, such as the IoT device examples described with respect to FIGS. 3 and 4, are one example. In an MEC network, processing power, such as servers, are moved closer to the edge of networks. For example, the aggregators 406 located within the fog device 402.

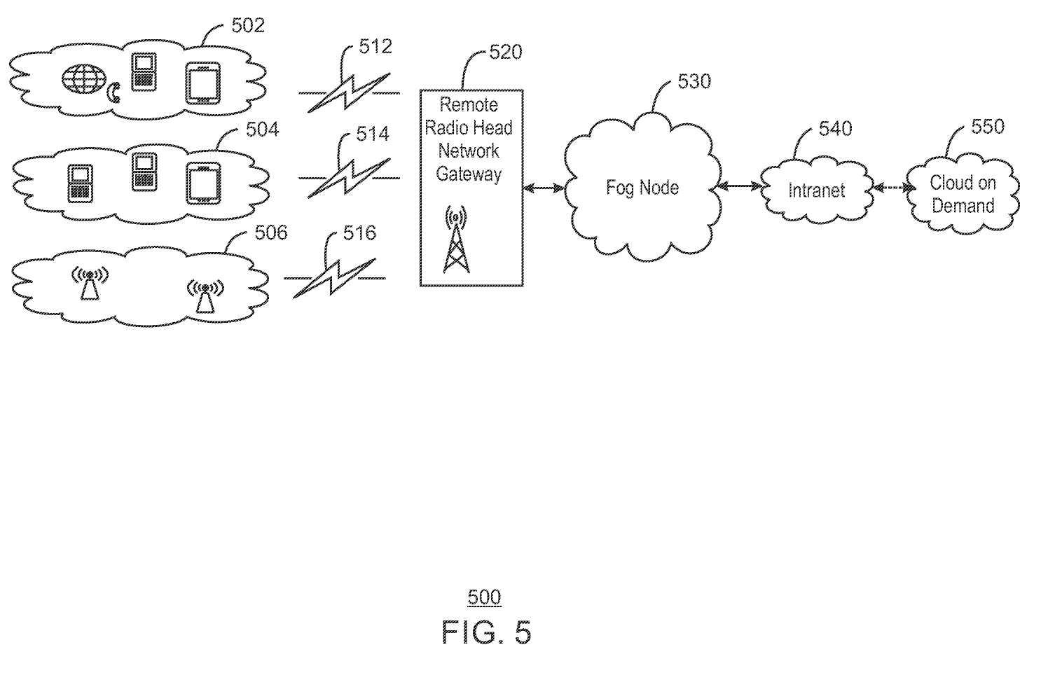

FIG. 5 illustrates a system 500 in accordance with some embodiments. For example, in some embodiments, system 500 can be an IoT system (for example, an IoT system such as a fog node system). System 500 can include one or more IoT devices. An exemplary IoT system 500 can include, for example, a first group of variable end node devices 502, a second group of variable end node devices 504, and a third group of variable end node devices 504. In some embodiments, one or more (or all) of the devices in the first group of variable end node devices 502, the second group of variable end node devices 504, and/or the third group of variable end node devices 504 can be IoT devices. Exemplary IoT system 500 can also include a first transmission medium 512, a second transmission medium 514, and a third transmission medium 516. For example, in some embodiments, first transmission medium 512, second transmission medium 514, and third transmission medium 516 can transmit information wirelessly. In some embodiments, first transmission medium 512, second transmission medium 514, and third transmission medium 516 can be variable lossy, variable bandwidth, variable latency transmission media (or variable lossy, variable bandwidth, variable latency transmission networks). In some embodiments, first transmission medium 512 can be one or more mobile adhoc networks. In some embodiments, second transmission medium 514 can be one or more cellular networks. In some embodiments, third transmission medium 516 can be one or more WiFi networks. In some embodiments, system 500 can include a remote radio head (RRH) network gateway 520, or any other type of gateway. In some embodiments, gateway 520 can be an IoT device. In some embodiments, first transmission medium 512 can transmit information between the first group of variable end node devices 502 and the remote radio head network gateway 520. In some embodiments, second transmission medium 514 can transmit information between the second group of variable end node devices 504 and the remote radio head network gateway 520. In some embodiments, third transmission medium 516 can transmit information between the third group of variable end node devices 506 and the remote radio head network gateway 520. In some embodiments, system 500 can include a fog node 530. In some embodiments, fog node 530 can be an IoT device. In some embodiments, fog node 530 can be a private highly available, low latency, wide bandwidth data center in a box, for example. In some embodiments, system 500 can include an intranet 540, or a cloud on demand 550, or both an intranet 540 and a cloud on demand 550. In some embodiments, intranet 540, or cloud on demand 550, or both intranet 540 and cloud on demand 550 can be a hybrid internal/external cloud device.

In some embodiments, fog node 530 receives partial object fragments (for example, partial image fragments) over one or more wired network, over one or more wireless network, or over a combination of wireless and wired networks.

In some embodiments, networks of IoT devices (IoT networks) such as fog networks (for example, system 500) can include a heterogeneous mixture of collaborating clients and edge devices using wired and/or wireless communications as interconnects. This can result in a dynamic infrastructure with variable performance characteristics. In some embodiments, in order to support transport and storage of complex data (for example, complex data such as large image and/or sequentially batched information payloads transferred across lossy, variable bandwidth, variable-latency networks) and an ability to overcome failures. For example, in some embodiments, data recombination (for example, data recombination such as complex edge data recombination for fog networks) can be implemented using data fragmentation and recombination. This can be implemented using data fragmentation and recombination of any type of data payload, including, for example, image fragmentation and recombination. In some embodiments, data such as large batched data can be fragmented, transported over IoT networks such as complex fog networks, and recombined at one or more destination points. In some embodiments, large file acquisition (for example, large image file acquisition) can be implemented across dynamic constrained wireless networks, wired networks, or a combination of wireless and wired networks.

Some embodiments relate to fog networks that are complex systems with, for example, many nodes may be dynamically changing with adding, subtracting, and/or augmenting of nodes, etc. with many parties involved in getting data from source to sync. Transmission data paths between source and sync can be sent over a variety of transmission modes including wireless transmission protocols such as LoRaWAN, WiFi, cellular, etc. and/or wired transmission protocols such as Ethernet, etc.

In some embodiments, data fragmentation and recombination can be implemented in a manner that provides real-time feedback of data construction (for, example, of image construction). In some embodiments, a time to live (TTL) of large data files such as image files can be managed, and configurable tolerances can be allowed for real world scenarios when the data files (or portions of the data files) will never arrive. In some embodiments, a probabilistic model can be generated for optimal end node transmission times and transmission durations. This can provide accurate models of node placement for real world deployments. In some embodiments, adaptive data rate can be implemented where the data rate transfer (for example, the image data rate transfer) can be dynamically changed based on a variety of environmental factors (for example, such as reflectors, interferers, etc.)

In some embodiments, auto-sequencing of packets can be implemented for both data packets received in-order and out of sequence. In some embodiments, missing packets can be detected and re-requested. In some embodiments, data fragments can be stored in a data storage device. In some embodiments, data packet fragments can be recombined for original payload reconstruction.

As discussed herein, a system such as system 500 can be used to transmit fragmented data, and partial image fragments can be received (for example, at a fog node) over one or more wireless network, one or more wired network, or a combination of wired and wireless networks.

In some embodiments, data fragmentation payload encapsulation is implemented. For example, in some embodiments, image fragmentation payload encapsulation is implemented. In some embodiments, an image fragmentation payload includes elements or fields including one or more of a format, an identifier, an ID, an integer describing part of the image, a timestamp, an image length, and a portion of the image. Such an example of data fragment encapsulation where the data is one or more image and includes each of those fields is illustrated in reference to Table 1. Table 1 illustrates an example of a partial image payload message using image fragment encapsulation.

```
TABLE 1
    {
    “format”: “PNG”,
    “uuid”: “40bac717-196c-11e4-9e9d-984fee001448”,
    “imageid”: “imageid”,
    “sectid”: 1,
    “ts”: 1459706857659,
    “imglen”: 1,
    “imgStr”:“iVBORw0KGgoAAAANSUhEUgAAABAAAAAQAQ
MAAAAlPW0iAABlBMVEUAAAD///+”
    }
```

In Table 1, the fields include a format (string) “format” which is a format of the complex data type (for example, in the case of an image, the format could be jpg, bmp, jpeg, wbmp, png, gif, tiff, etc.) Another field in Table 1 is a uuid (string) “uuid”, which is an identifier of the originating edge node, where the identifier is unique to the system. A third field in Table 1 is an “imageid” (string) identifier (ID) of the image. The “imageid” should be unique per the uuid field. Between the uuid and the imageid, they make up a unique identifier for an image. The fourth field in Table 1 is “sectid”, which is an integer (for example, between 0-N) describing a part of the image. Each of the image parts can be, for example, a fragment of the image object. The fifth field in Table 1 is a “ts” field, which is a timestamp (for example, a Unix epoch timestamp) when the image part of recorded. The sixth field in Table 1 is an “imglen” (image length) identifying the number of fragments comprising the complete image. That is, imglen (or image length) identifies how many total sections or fragments (or integers 0 through N) are included in imageid. In some embodiments (for example, with wireless networks) it is noted that imglen (image length) can change as transmission progresses. The sixth field in Table 1 is an “imgstr” (image string) identifying the fragment data portion (for example, the part of the image). This field can be encoded (for example, using base64 encoding).

As described herein, fragment recombination can be implemented according to some embodiments. In some embodiments, a lightweight stateless architecture can be used with a highly concurrent distributed, resilient, message driven and scalable solution. This can help to ensure predictable and minimal resource consumption according to some embodiments. In some embodiments, non-blocking communication can allow recipients to only consume resources while active and can reduce system overhead. Although some embodiments herein refer to image fragmentation and recombination, other embodiments exist that relate to other data fragmentation and recombination implementations. For example, some embodiments relate to any data format. Some embodiments may be implemented relating to many different binary and non-binary formats, for example.

In some embodiments, data recombination is implemented in which one or more receiving node knows a start in a received stream a byte or group of bytes (for example, in a data fragment) that represents a start. Multiple clients can be publishing to the receiving endpoint (or node). A different object (for example, a different image in some embodiments) can be received by the receiving node from a different endpoint. Each part (or packet of information) has a unique identifier (for example, a different imageid). The unique identifier can be associated with a particular data object (for example, a particular image). Each data object can be composed of a partial data objects that can be received in any order. An object is completed when all parts are received. In some embodiments (for example, using a transmission medium such as LoRaWAN), transmission and receipt of the data object might take a long time (for example, 12 hours).

In some embodiments, management can be implemented of fragments received out of order. In some embodiments, a time to live (TTL) can be used for resource management. If all partial components are not received within a particular time, a process of waiting for all of the fragments can be killed. In this situation, partial components can be stored in a different storage device (or storage location within the same device) from where completed objects are stored. If all parts of an object have arrived, they can be sorted into the correct order. For an object such as an image to be visible and clear, a marker of each individual image can be stored in the list.

In some embodiments, multiple nodes (for example, multiple end nodes or multiple IoT devices) can transmit images (or other data) by splitting it into parts (or fragments) using unique uuid and unique imageid, for example. These parts (or fragments) can arrive out of order and may include duplicates. A receiving node (for example, such as a gateway, a fog node, or other IoT device) can acknowledge receipt of the fragments. If an imageid has not been seen before, an actor (or agent) can be created and the fragment can be added to a list of fragments for that image (or other data payload). A list of actors (or agents) can be maintained with a one to one relationship that is uniquely identified (for example, uniquely identified with the uuid and imageid combination). As fragments arrive, they can be added to the relevant actor (or agent) list of fragments, and duplicates can be ignored (for example, without being added twice). Each fragment can describe the total number of fragments necessary to build the data payload (for example, the total number of fragments necessary to build the image). In some embodiments, this total number of fragments can change after the first fragment has been received and before the last fragment is received for a specific payload (for example, for a specific image). In some embodiments, a continual checking can be implemented to see if all expected parts (for example, all expected fragments) have arrived.

In some embodiments, a time series database can be used. The time series database can record details on performance of building the data payload (for example, building the image). In some embodiments, for example, the recorded performance details can be used to place nodes such as end nodes. If all fragments (parts) have arrived they can then be sorted and saved (for example, in a storage device such as a persistent database storing the complete data payload). If all fragments (parts) have not arrived within a certain time deadline the failure can be recorded and the partial payload including received fragments can be stored, an attempt to fix the payload (or image) can be implemented, and/or a retransmit can be requested.

In some embodiments, data can be fragmented at end nodes (or endpoint devices) such as, for example, any of the end node devices in FIG. 4 or in groups 502, 504 or 506 of FIG. 5, or at an aggregator such as, for example, any of the aggregators 406 of FIG. 4. The fragments can then be sent to one or more other device where the fragments are recombined, such as, for example, gateway 520, fog node 530, intranet 540, or cloud on demand 550 of FIG. 5, or to another device within fog device 402 of FIG. 4, gateway 310, cloud 302, or server 304 of FIG. 3 or FIG. 4, for example. In some embodiments, data recombination can be implemented at an aggregator, a gateway, or a fog node. In some embodiments, data recombination as described and/or illustrated herein can be implemented at any node in a network (for example, at any node in an IoT network). In some embodiments, data recombination can be implemented at two or more different nodes. For example, in some embodiments, data recombination can be implemented partially at one node and partially at one or more other nodes. In some embodiments, for example, data recombination can be implemented in parallel at different nodes (for example, if the information is being transmitted through different nodes in parallel). In some embodiments, for example, one transmission path in a network may be a higher speed transmission path than another transmission path, and the higher speed transmission path may be better able to deal with fragmentation and packet delivery much faster than the other transmission path, which may be a transmission path that is more lossy. In some embodiments, data fragmentation and recombination can be implemented in a manner that can expand and contract it's performance based on the link characteristics. That is, in some embodiments, the network can strategically determine where to break up the data fragments and where to recombine the fragments based on transmission characteristics of the transmission paths between the nodes.

It is noted that in some embodiments (for example, in some wireless transmission embodiments) object length (or the number of fragments) can change as transmission progresses. For example, in some embodiments, payload size and the number of fragments may dynamically adjust (for example, in a case of image data where something blocks the image capture). For example, large packets might be sent when conditions are good and smaller packets might be sent when conditions are not good. As the payload is sent, conditions might change or transmission is not working well, fragment size might be dynamically reduced and the number of fragments might be increased (for example, by dynamically adjusting sectid and/or imglen of Table 1 for a particular uuid and imageid combination). This can be implemented, for example, if packets are being dropped or multiple retries are occurring. For example, an out of band or in-band control message can be sent back to the endpoint where the packets are being fragmented indicating that conditions are not ideal and smaller fragments should be used. This can be dynamically implemented without having to start over from the beginning by fragmenting the entire object. Remaining portions (for example, non-received fragments) of the object can be re-fragmented in some embodiments. In some embodiments, the number of fragments can be increased (and size of fragments decreased) and in some embodiments the number of fragments can be decreased (and size of fragments increased). In some embodiments, the dynamic adjustment of number of fragments and/or size of fragments can be implemented between a node where the fragmentation is occurring and where the recombination is occurring, for example.

In some embodiments, an actor (or agent) has a unique one to one relationship with each imageid. Upon receipt, if the imageid does not exist in a list of actors, a new actor is created for the new imageid to deal with the particular image (or data payload other than an image in some embodiments). In some embodiments, the actor lives in memory until all parts (or fragments) of the image have been received or until a time to live (TTL) has elapsed. In some embodiments, the actor is temporally stored (for example, temporally stored to a persistent storage such as a disk) and restored to memory when a new fragment arrives. In this manner, it doesn't matter what fragment is received at a particular time or when it is received. The number of parts (or fragments) can be dynamically adjusted and an adjustment in the determination as to whether all parts have been received can be determined based on the dynamic adjustments (for example, using the part number or sectid for a particular payload as well as the length or imglen). Once it is determined that all fragments have been received, the fragments can all be put together and ordered correctly. In some embodiments, the number of packets (fragments) can go up or down, and the receiving node can react accordingly. In some embodiments, the receiving node will use the various received fragments to determine the final number of necessary packets and will make a decision on whether all packets have been received based on the received fragments and the received length identifying the necessary number of packets for the particular payload (for example, the imglen or image length field).

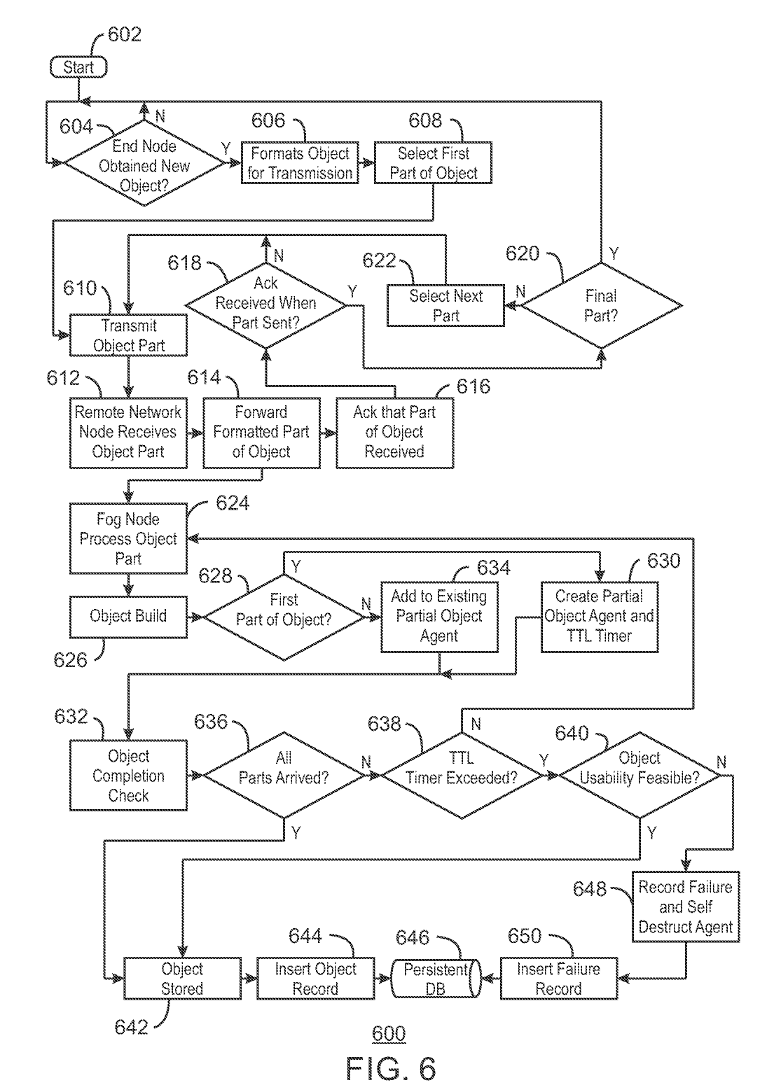

FIG. 6 illustrates data fragmentation and recombination 600 in accordance with some embodiments. In some embodiments, for example, data fragmentation can be implemented in an end node as illustrated in FIG. 6. In some embodiments, for example, data recombination can be implemented in a fog node as illustrated in FIG. 6. However, in some embodiments, data fragmentation can be implemented in other devices than end nodes (for example, such as in other IoT devices than end nodes). Similarly, in some embodiments, data recombination can be implemented in other devices than fog nodes (for example, such as in other IoT devices than fog nodes).

The data fragmentation and recombination 600 begins at start 602. At 604, a determination is made as to whether one or more end node (or some other device than an end node) has obtained a new object. For example, in some embodiments, the new object can be an image taken by a camera (for example, at an end node). In some embodiments, the new object can be, for example, data, a data payload, and/or an image, etc. If a new object has not been obtained at 604, flow remains at 604 until a new object has been obtained. If a new object is obtained at 604, the end node or other device formats the object for transmission at 606. The first part of the object is selected at 608. The first object part is then transmitted at 610. A remote network node receives the transmitted object part at 612 and the formatted part of the object is forwarded (for example, to a fog node) at 614. At 616, an acknowledgement (ACK or Ack) can be made that the part of the object has been received (for example, from the fog node). At 618, a determination is made as to whether the acknowledgement was received in response to the part of the object being sent. If a determination is made at 618 that the acknowledgement was not received, flow returns to 610 to re-transmit the object part. If a determination is made at 618 that the acknowledgement was received, a determination is made at 620 as to whether the most recently transmitted part was the final part of the object. If the determination at 620 is that the most recently transmitted part was not the final part of the object, the next part is selected at 622 and then transmitted at 610. If the determination at 620 is that the most recently transmitted part was the final part of the object, flow returns to 604 to determine whether a new object has been obtained.

When the formatted part of the object is forwarded at 614, the object part is processed at a receiving device (for example, such as a fog node) at 624 and object build is performed at 626 (and/or is implemented at some or all of the elements to the right of 626). At 628 a determination is made as to whether the received object part is the first part of the object. If the determination at 628 is that the received object part is the first part of the object, a partial object agent and a time to live (TTL) timer are created at 630 and an object completion check is implemented at 632 (and/or is implemented at some or all of the elements to the right of 632). If the determination at 628 is that the received object part is not the first part of the object, the received object part is added to the existing partial object agent at 634 and an object completion check is implemented at 632 (and in some embodiments, at the elements to the right of 632). At 636 a determination is made as to whether all parts of the object have been received (for example, have arrived at the fog node). If it is determined at 636 that all parts of the object have not been received, a determination is made at 638 as to whether the time to live (TTL) timer has been exceeded. If the determination at 638 is that the TTL timer has not expired, flow returns to 624 to process the next received object part. If the determination at 638 is that the TTL timer has expired, a determination is made at 640 as to whether an object usability is feasible. If the object usability is feasible at 640, or if all parts have arrived at 636, the object is stored at 642 (and/or is implemented at some or all of the elements to the right of 642). For example, in some embodiments, this can be implemented by inserting an object record at 644 in a persistent database 646 or other storage device. If the object usability is not feasible at 640, at 648 a failure is recorded and the partial object agent is self-destructed, and a failure record is inserted at 650 in the persistent database 646 (or other storage device).

In some embodiments, data fragmentation is implemented at 604, 606, 608, 610, 612, 614, 616, 618, 620 and 622 (for example, at an end node). In some embodiments, one or more of 612, 614 and/or 616 can be implemented at a different node (for example, at a remote network node). In some embodiments, data fragmentation such as the data fragmentation illustrated in FIG. 6 can be implemented at any end node illustrated or described herein (for example, at any of the end node devices in group 502, group 504 or group 506 illustrated in FIG. 5). In some embodiments, data fragmentation such as the data fragmentation illustrated in FIG. 6 can be implemented at any IoT device (for example, at any IoT device illustrated or described herein such as, for example, gateway 520 of FIG. 5 or IoT device 1300 of FIG. 13).

In some embodiments, data recombination is implemented at 624, 626, 628, 630, 632, 634, 636, 638, 640, 642, 644, 646, 648 and 650 (for example, at a fog node). In some embodiments, data recombination such as the data recombination illustrated in FIG. 6 can be implemented at any fog node illustrated or described herein (for example, at fog node 530 illustrated in FIG. 5). In some embodiments, data recombination such as the data recombination illustrated in FIG. 6 can be implemented at any IoT device (for example, at any IoT device illustrated or described herein such as, for example, gateway 520 of FIG. 5 or IoT device 1300 of FIG. 13).

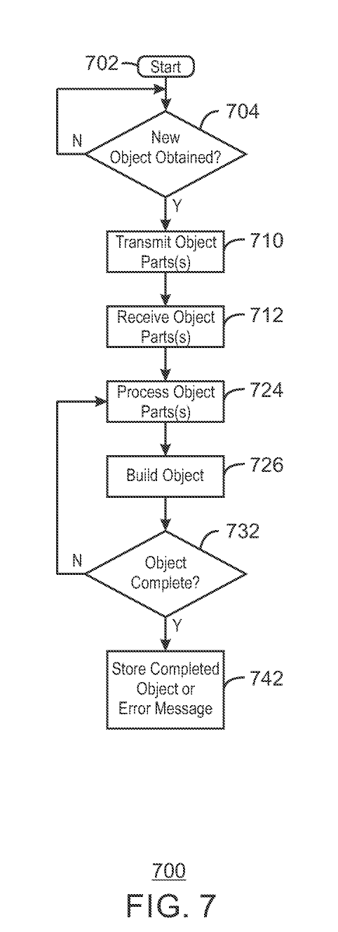

FIG. 7 illustrates data fragmentation and recombination 700 in accordance with some embodiments. In some embodiments, data fragmentation and recombination 700 can be the same as or similar to data fragmentation and recombination 600. In some embodiments, for example, data fragmentation of FIG. 7 can be implemented in an end node. In some embodiments, for example, data recombination of FIG. 7 can be implemented in a fog node. However, in some embodiments, data fragmentation of FIG. 7 can be implemented in other devices than end nodes (for example, such as in other IoT devices than end nodes). Similarly, in some embodiments, data recombination of FIG. 7 can be implemented in other devices than fog nodes (for example, such as in other IoT devices than fog nodes).

The data fragmentation and recombination 700 begins at start 702. At 704, a determination is made as to whether an end node (or some other device than an end node) has obtained a new object. For example, in some embodiments, the new object can be an image taken by a camera (for example, at an end node). In some embodiments, the new object can be, for example, data, a data payload, and/or an image, etc. If a new object has not been obtained at 704, flow remains at 704 until a new object has been obtained. If a new object is obtained at 704, one or more parts of the object are then transmitted at 710. In some embodiments, a remote network node receives the transmitted object part(s) at 712 and the formatted part of the object is forwarded (for example, to a fog node).

When the formatted part of the object is forwarded, the object part is processed at a receiving device (for example, such as a fog node) at 724 and object build is performed at 726. An object completion check is implemented at 732. If the object has completed the object or an error message is stored at 742. If the object has not completed at 732, flow returns to 724 to process the next object part.

In some embodiments, data fragmentation is implemented at 704 and 710 (for example, at an end node). In some embodiments, 712 can be implemented at a different node (for example, at a remote network node). In some embodiments, data fragmentation such as the data fragmentation illustrated in FIG. 7 can be implemented at any end node illustrated or described herein (for example, at any of the end node devices in group 502, group 504 or group 506 illustrated in FIG. 5). In some embodiments, data fragmentation such as the data fragmentation illustrated in FIG. 7 can be implemented at any IoT device (for example, at any IoT device illustrated or described herein such as, for example, gateway 520 of FIG. 5 or IoT device 1300 of FIG. 13).

In some embodiments, data recombination is implemented at 726, 732 and 742 (for example, at a fog node). In some embodiments, data recombination such as the data recombination illustrated in FIG. 7 can be implemented at any fog node illustrated or described herein (for example, at fog node 530 illustrated in FIG. 5). In some embodiments, data recombination such as the data recombination illustrated in FIG. 7 can be implemented at any IoT device (for example, at any IoT device illustrated or described herein such as, for example, gateway 520 of FIG. 5 or IoT device 1300 of FIG. 13).

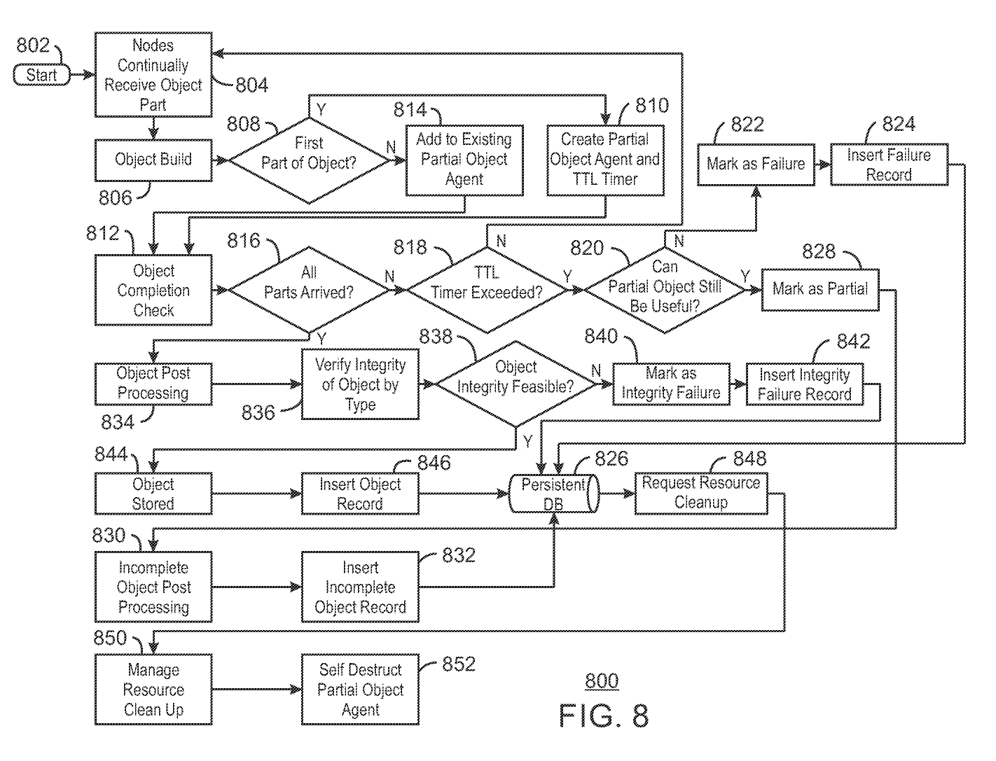

FIG. 8 illustrates data recombination 800 in accordance with some embodiments. In some embodiments, for example, data recombination 800 can be implemented in one or more fog node. However, in some embodiments, data recombination 800 can be implemented in one or more other devices than fog nodes (for example, such as in other IoT devices than fog nodes, or in any type of compute nodes).

Data recombination 800 begins at start 802. At 804 one or more nodes (for example, one or more fog nodes or one or more IoT nodes, etc.) continually update an object part (for example, update a data fragment such as an image fragment or image part). Then the object is built at 806 (and/or is implemented at some or all of the elements to the right of 806). At 808 a determination is made as to whether the current object part is the first part of the object. If the determination at 808 is that it is the first part of the object, a partial object agent (or partial object actor) and a time to live (TTL) timer are created at 810. Then at 812 (and/or at some or all of the elements to the right of 812) an object completion check is implemented. If the determination at 808 is that it is not the first part of the object, the received object part is added to the existing partial object agent corresponding to that object at 814, and flow moves to 812 (and/or to the blocks to the right of 812).

At 816 a determination is made as to whether all parts have arrived for the current object. If the determination at 816 is that all parts have not arrived, a determination is made at 818 as to whether the time to live (TTL) timer has been exceeded. If the determination at 818 is that the TTL timer has not been exceeded, flow returns to 804 to receive a next part of the object. If the determination at 818 is that the time to live (TTL) timer has been exceeded, a determination is made at 820 as to whether the partial object can still be useful. If the determination at 820 is that the partial object cannot still be useful, then a failure is marked for the partial object at 822. Then at 824 a failure record is stored in a storage device such as persistent database 826. In some embodiments, a dispatch to the node sending the fragments can be made for a packet re-request of one or more fragments can also be made at this point. If the determination at 820 is that the partial object cannot still be useful, then the object is marked as a partial object at 828, incomplete object post processing is implemented at 830, and an incomplete object record is stored (inserted) at 832 into a storage device such as, for example, persistent database 826.

If the determination at 816 is that all parts have arrived, object processing is implemented at 834 (and/or is implemented at some or all of the elements to the right of 834). At 836 the integrity of the object is verified by type. At 838 a determination is made as to whether the object integrity is feasible. If the determination at 838 is that the object integrity is not feasible, a mark can be made of an integrity failure indication corresponding to the object at 840. An integrity failure record can then be inserted at 842 into a storage device such as persistent database 826. If the determination at 838 is that the object integrity is feasible, the object is stored at 844 (and/or is implemented at some or all of the elements to the right of 844). At 846 an object record is inserted into a storage device such as persistent database 826. Once storage to the storage device (such as persistent database 826) has occurred, resource cleanup is requested at 848, and resource cleanup is implemented at 850 and/or 852. In some embodiments, resource cleanup can be managed at 850 and/or self-destruction of the partial object agent (or partial object actor) can be implemented at 852.

In some embodiments, data recombination 800 can be implemented at a fog node. In some embodiments, data recombination 800 can be implemented at any fog node illustrated or described herein (for example, at fog node 530 illustrated in FIG. 5). In some embodiments, data recombination 800 can be implemented at any IoT device (for example, at any IoT device illustrated or described herein such as, for example, gateway 520 of FIG. 5 or IoT device 1300 of FIG. 13).

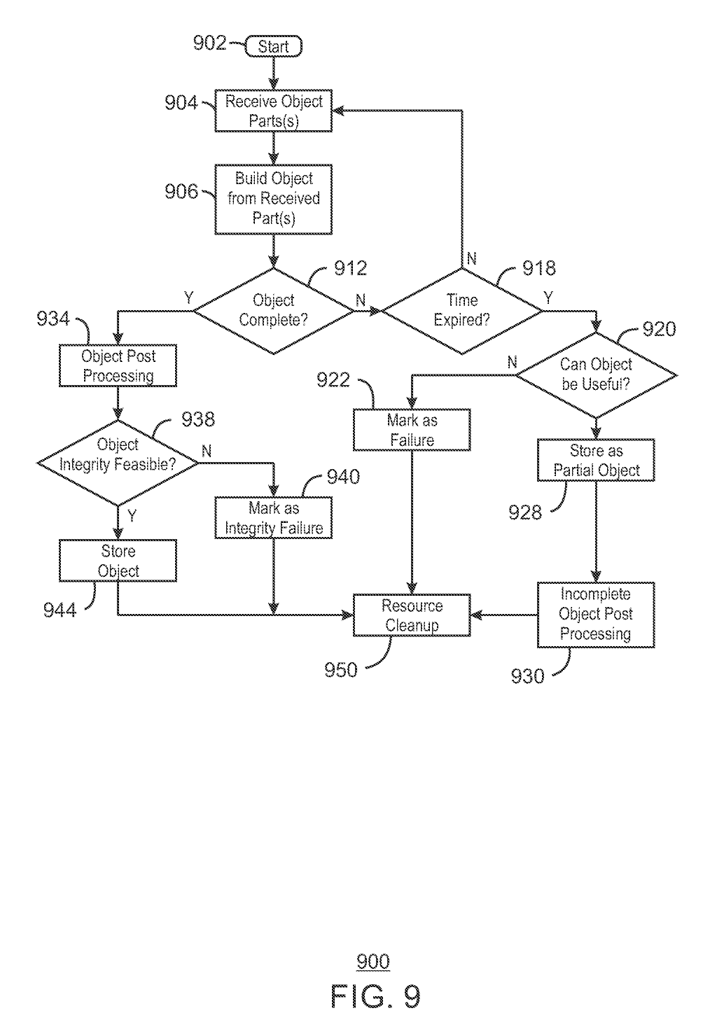

FIG. 9 illustrates data recombination 900 in accordance with some embodiments. In some embodiments, data fragmentation and recombination 900 can be the same as or similar to data fragmentation and recombination 800. In some embodiments, for example, data recombination 900 can be implemented in one or more fog node. However, in some embodiments, data recombination 900 can be implemented in one or more other devices than fog nodes (for example, such as in other IoT devices than fog nodes, or in any type of compute nodes).

Data recombination 900 begins at start 902. At 904 one or more nodes (for example, one or more fog nodes or one or more IoT nodes, etc.) continually update one or more object parts (for example, update one or more data fragments such as one or more image fragments or one or more image parts). The object is built at 906 from the one or more received object parts. At 912 a determination is made as to whether the object is complete. If the determination at 912 is that the object is not complete, a determination is made at 918 as to whether a predetermined time has expired (for example, whether a time to live or TTL time has been exceeded).

If the determination at 918 is that the predetermined time has not expired, flow returns to 904 to receive a next part of the object. If the determination at 918 is that the predetermined time has expired, a determination is made at 920 as to whether the partial object can still be useful. If the determination at 920 is that the partial object cannot still be useful, then a failure is marked for the partial object at 922 (for example, in a storage device such as a persistent database). If the determination at 920 is that the partial object can still be useful, then the object is stored in a storage device as a partial object, and an incomplete post processing procedure is implemented at 930.

If the determination at 912 is that the object is complete, object post processing is implemented at 934. At 938 a determination is made as to whether the object integrity is feasible. If the determination at 938 is that the object integrity is not feasible, a mark can be made as an integrity failure indication corresponding to the object at 940. This integrity failure record can be inserted into a storage device such as a persistent database, for example. If the determination at 938 is that the object integrity is feasible, the object is stored at 944 in a storage device (such as a persistent database). After 922, 930, 940 and 944 resource cleanup is implemented at 950. The resource cleanup managed at 950 can include self-destruction of the a partial object agent (or partial object actor) used to implement one or more of the elements of data recombination 900.

In some embodiments, data recombination 900 can be implemented at a fog node. In some embodiments, data recombination 900 can be implemented at any fog node illustrated or described herein (for example, at fog node 530 illustrated in FIG. 5). In some embodiments, data recombination 900 can be implemented at any IoT device (for example, at any IoT device illustrated or described herein such as, for example, gateway 520 of FIG. 5 or IoT device 1300 of FIG. 13).

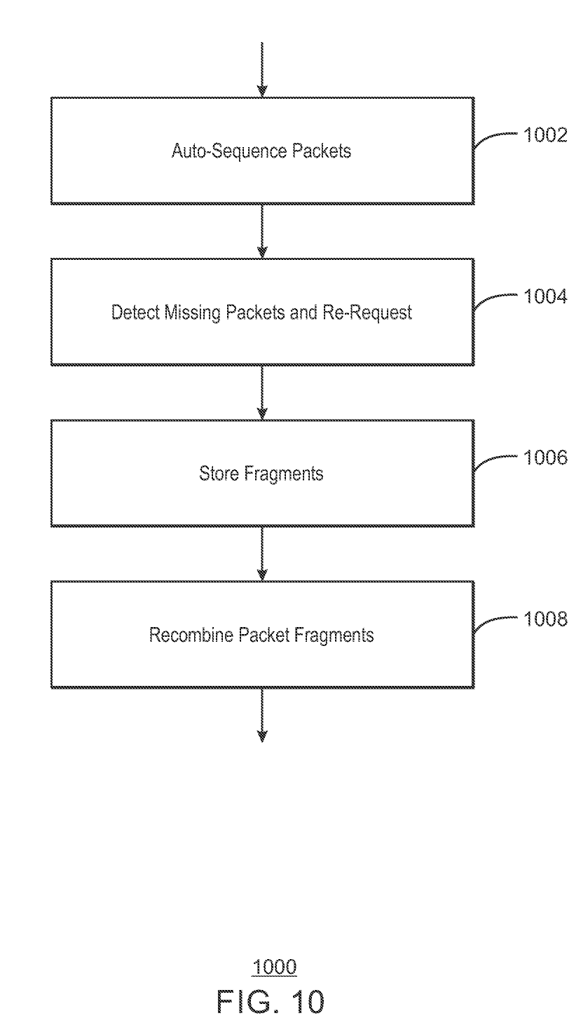

FIG. 10 illustrates data recombination 1000 in accordance with some embodiments. In some embodiments, for example, the data packets can be image packets. In some embodiments, for example, data recombination 1000 can be implemented in a fog node. However, in some embodiments, data recombination 1000 can be implemented in other devices than fog nodes (for example, such as in other IoT devices than fog nodes). In some embodiments, data recombination 1000 can be the same as or similar to any data recombination described or illustrated herein.

Data recombination 1000 begins with auto-sequencing of one or more data packets (or data fragments) at 1002. The auto-sequenced packets can be received in order (or in sequence), out of order (or out of sequence), or both in order (in sequence) and out of order (out of sequence). At 1004 missing packets are detected, and packets can be re-requested. Data fragments can be stored in a data store at 1006. Packet fragments can be re-combined at 1008 for original data payload reconstruction.

In some embodiments, data recombination 1000 can be implemented at a fog node. In some embodiments, data recombination 1000 can be implemented at any fog node illustrated or described herein (for example, at fog node 530 illustrated in FIG. 5). In some embodiments, data recombination 1000 can be implemented at any IoT device (for example, at any IoT device illustrated or described herein such as, for example, gateway 520 of FIG. 5 or IoT device 1300 of FIG. 13).

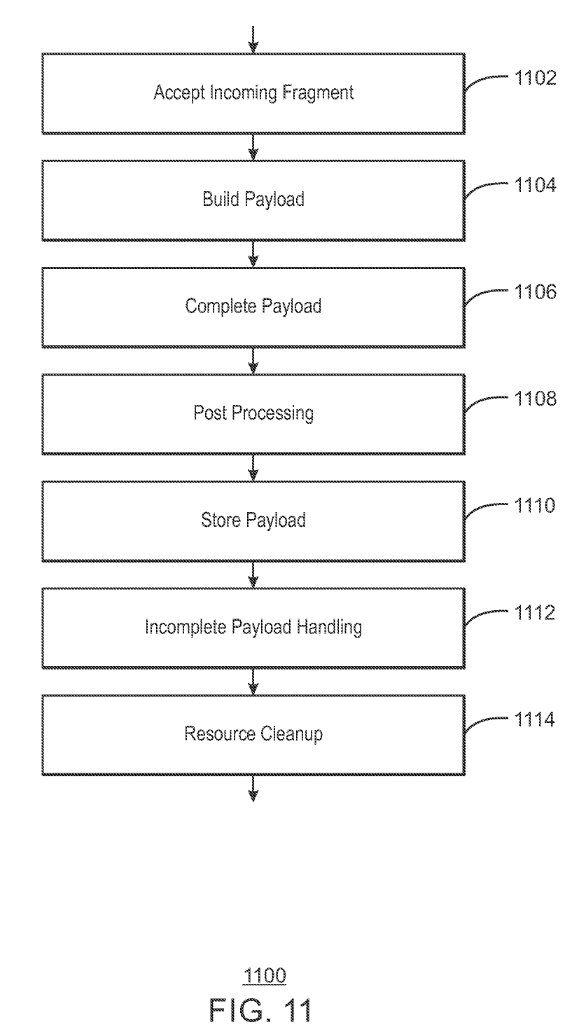

FIG. 11 illustrates data recombination 1100 in accordance with some embodiments. In some embodiments, for example, data recombination 1100 can be implemented in a fog node. However, in some embodiments, data recombination 1100 can be implemented in other devices than fog nodes (for example, such as in other IoT devices than fog nodes). In some embodiments, data recombination 1100 can be the same as or similar to any data recombination described or illustrated herein.

In some embodiments, data recombination 1100 can begin with accepting one or more data packets (or data fragments) at 1102. In some embodiments, for example, the data packets can be image packets. In some embodiments, for example, fragments can be accepted at 1102 in any order and from a single batch of from multiple different batches at the same time. The payload is built at 1104. In some embodiments, payload building of 1104 can be implemented by determining the fragment order from the partial data encapsulation and the data set to which the fragment belongs. For example, in some embodiments, the fragment may belong to a current data object under construction or can be part of a new data object.

In some embodiments, data payload completion is implemented at 1106. In some embodiments, 1106 can include, for example, data payload completion and integrity checks (for example, to determine if all component data fragments have been received). Post processing is implemented at 1108. In some embodiments, for example, post processing 1108 can involve data integrity checking and PASS/FAIL decisions. The data payload is stored at 1110. In some embodiments, for example, the complete data payload can be stored in a storage device such as a data base. Incomplete data payload handling can be implemented at 1112. In some embodiments, incomplete payload handling 1112 can include remnant management. In some embodiments, incomplete payload handling 1112 can include storing an incomplete payload, and/or marking the payload as incomplete (for example, in the storage device). Resource cleanup can be implemented at 1114. This can include, for example, an operation to self-destruct a partial data object agent.

In some embodiments, data recombination 1100 can be implemented at a fog node. In some embodiments, data recombination 1100 can be implemented at any fog node illustrated or described herein (for example, at fog node 530 illustrated in FIG. 5). In some embodiments, data recombination 1100 can be implemented at any IoT device (for example, at any IoT device illustrated or described herein such as, for example, gateway 520 of FIG. 5 or IoT device 1300 of FIG. 13).

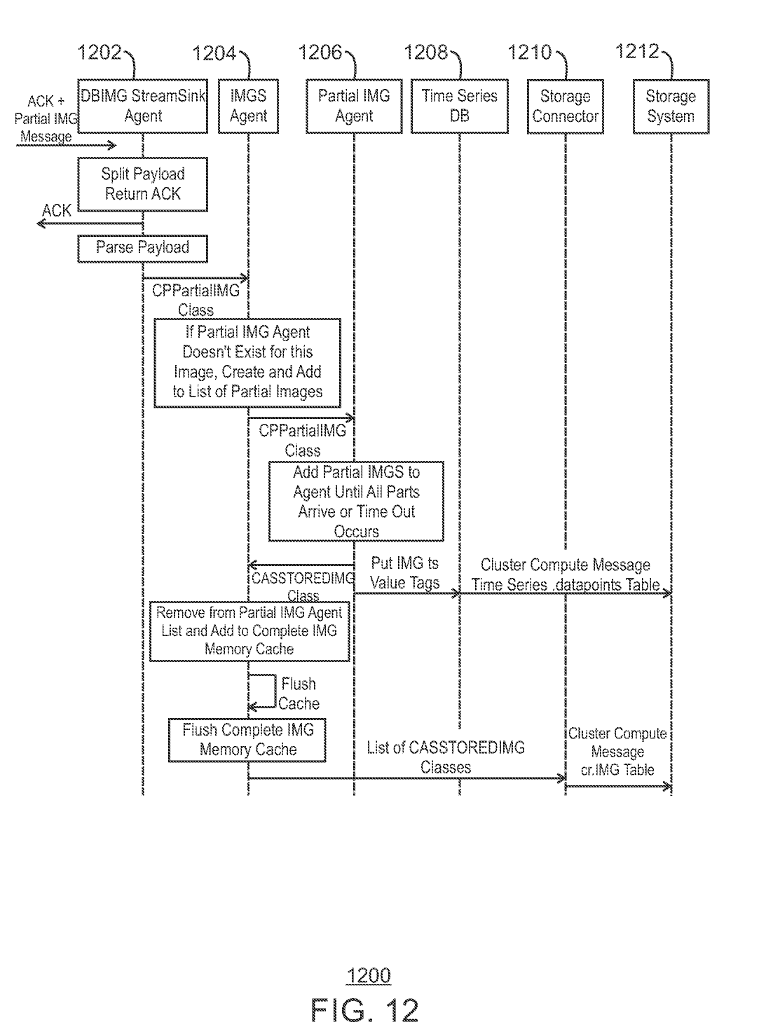

FIG. 12 illustrates a partial image data sequence diagram 1200 in accordance with some embodiments. Although FIG. 12 illustrates a sequence diagram 1200 relating to image recombination, other embodiments can be implemented with other types of data than image data with similar data sequence diagrams to diagram 1200. In some embodiments, diagram 1200 includes a DBIMG StreamSink Agent 1202 (database image stream sink agent 1202), an IMGS Agent 1204 (images agent 1204), a partial IMG Agent 1206 (partial image agent 1206), a time series database 1208 (ts dB 1208), storage connector 1210, and a storage system 1212. In some embodiments, one or more of agents 1202, 1204 and 1206, and/or one or more of database 1208, storage connector 1210, and storage system 1212 can be included in an IoT network, in one or more IoT device, in one or more gateways, in one or more fog nodes, in one or more other IoT nodes, and/or in any combination of different types of IoT nodes, for example.

An acknowledge (ACK) and a partial image message are received at the agent 1202 from the node sending the fragments. The agent 1202 can receive multiple packets from one or more endpoints, and splits the payload (for example, into fragments), returns an acknowledge (ACK), parses the payload, and sends a CPPartiallMG class to agent 1204. In some embodiments, CPPartiallMG class can be a partial image case class which can export it's constructor parameters and can provide a recursive decomposition mechanism via pattern matching. In some embodiments, CPPartiallMG class can include, for example, an eta string, a lifeleft string, a missing string, a starttime string, a tag (ConfigTag), an image key (imgkey), a current count (currcount) integer, and/or a targetcount (target count) integer, among others. The eta can be an estimated time of arrival displayed as a string. lifelived can be the amount of time this class has existed described as a string, lifeleft can be an amount of time left such as a remaining time to live, missing can be the percentage missing described as a string, starttime can be the time that first fragment arrived described as a string, tag can be a config tag, imgkey can be an image key, currcount can be a current number of fragments received for the image, and targetcount can be the number of fragments that need to be received before the image will be complete. Config tag can be, for example, a configuration tag that includes an end string (for example, an endpoint type protocol identifier), a sink string (for example, an endpoint to which data is to be moved), a ktype string (for example, a type of message received), a pubtopic string (for example, for traceability the endpoint to which to travel), and/or a sinktopic string (for example, an endpoint point to which to listen), among others. IMGKey (image key) can be a case class including, for example, that includes a uuid string (for example, a unique identifier of the device in the system that generated the fragment) and/or an imageid (for example, a unique identifier of the image for the device that generated the fragment), among others.

If a partial IMG agent does not exist for the current image, a new partial image agent 1206 is created and added to a list of partial images. Agent 1204 sends the CPPartiallMG class to the partial image agent 1206 (which was either already existing or newly created by the agent 1204). Agent 1206 adds the new partial IMGS to the agent until all parts of the payload arrive, or until a time out occurs. Agent 1206 sends a CASSTOREIMG class to agent 1204. In some embodiments, the CASSTOREIMG class can include a format string, a uuid string, an imageid string, a sectid integer, a timestamp (ts), an image length (imglen), and/or full image bytes (or image array bytes). The format can be a data format such as, for example, PNG, JPEG, BMP, or WBMP. The uuid can be a unique identifier of the device in the system that generated the fragment. The imageid can be a unique identifier of the image for the device that generated the fragment. The sectid can be the fragment ID of the first fragment to arrive for the completed image. The timestamp (ts) can be a time represented (for example, as long from epoch) when the first fragment arrived. The image length (imglen) can be the number of fragment used to build the image. Full image bytes (fullimagebytes) or image array byte (imgarraybyte) can be the complete image as an array of bytes.

Agent 1206 then puts one or more image time series (IMG ts) value tags in the time series database 1208. Database 1208 can store information, for example, about what has been achieved, home many pieces have been restored for a particular image at a particular point in time, etc. By storing information about how long it took to receive or store the images, information can be gathered about the topology of the network and/or about devices in the field, for example. For example, in some embodiments information may be stored such as where transmission of an image may take longer or shorter based on seasons of the year (for example, where leaves block a view of a camera in the summertime) or based on a day and time of the week (for example, where a truck blocks a view of a camera of a transmission or receiver device because it is parked in a particular location between 3 pm and 4 pm on Tuesdays). In this manner, it can be determined that one or more devices could advantageously be repositioned, for example. Database 1208 sends cluster compute message time series datapoints table data to storage system 1212 via connector 1210.

After receiving the CASSTOREIMG class from the agent 1206, the agent 1204 removes the partial image from the partial image agent list and adds it to a complete image memory cache. Agent 1204 then flushes the complete image memory cache. A list of CASSTOREIMG classes is sent from agent 1204 via connector 1210 to the storage system 1212, which receives a cluster compute message cr.IMG table. The cr.IMG table can be a NOSQL database table, for example, and can include a format text, a uuid text, an imageid text, a sectid integer, a is (timestamp) map, an imgarraybyte blob, and an imglen (image length) integer, among others.

FIG. 12 illustrates protocol sequences involved in the creation of a complete image from partial images according to some embodiments. However, other protocol sequences can be involved in complete image creation according to some embodiments.

In some embodiments, a graphical user interface (GUI) can be used to show progress of image processing (for example, metadata associated with a system in operation). The graphical user interface can illustrate, for example, an end point identifier, a node start time, a UUID, and Imageid, a current count, a target count, a percent completion, an existing sections identifier, other section information such as sections not yet arrived, an estimated time of arrival (ETA), a life lived, a life left, a time to live (TTL), and/or an expected completion time, among others.

FIG. 13 is a block diagram of an example of components that may be present in an IoT device 1300 for implementing data fragmentation and/or data recombination. In some embodiments, IoT device 1300 can implement any of the techniques illustrated or described herein. In some embodiments, for example, IoT device 1300 can be one or more end nodes such as any of the end nodes illustrated or described herein (for example, such as one or more of the devices included in group 502, group 504, and/or group 506 of FIG. 5). In some embodiments, for example, IoT device 1300 can be one or more gateways such as any of the gateways illustrated or described herein (for example, such as gateway 520 of FIG. 5). In some embodiments, for example, IoT device 1300 can be one or more fog nodes such as any of the fog nodes illustrated or described herein (for example, such as fog node 530 of FIG. 5). The IoT device 1300 may include any combinations of the components shown in the example. The components may be implemented as ICs, portions thereof, discrete electronic devices, or other modules, logic, hardware, software, firmware, or a combination thereof adapted in the IoT device 1300, or as components otherwise incorporated within a chassis of a larger system. The block diagram of FIG. 13 is intended to show a high level view of components of the IoT device 1300. However, some of the components shown may be omitted, additional components may be present, and different arrangement of the components shown may occur in other implementations.

The IoT device 1300 may include a processor 1302, which may be a microprocessor, a multi-core processor, a multithreaded processor, an ultra-low voltage processor, an embedded processor, or other known processing element. The processor 1302 may be a part of a system on a chip (SoC) in which the processor 1302 and other components are formed into a single integrated circuit, or a single package, such as the Edison™ or Galileo™ SoC boards from Intel. As an example, the processor 1302 may include an Intel® Architecture Core™ based processor, such as a Quark™, an Atom™, an i3, an i5, an i7, a Xeon®, a Xeon Phi™ co-processor, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A9 processor from Apple® Inc., a Snapdragon™ processor from Qualcomm® Technologies, Inc., or an OMAP™ processor from Texas Instruments, Inc.

The processor 1302 may communicate with a system memory 1304 over a bus 1306. Any number of memory devices may be used to provide for a given amount of system memory. As examples, the memory can be random access memory (RAM) in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard, such as LPDDR3 or LPDDR4 that will offer extensions to LPDDR2 to increase bandwidth. In various implementations the individual memory devices may be of any number of different package types such as single die package (SDP), dual die package (DDP) or quad die package (Q17P). These devices, in some embodiments, may be directly soldered onto a motherboard to provide a lower profile solution, while in other embodiments the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. For example, a memory may be sized between 2 GB and 16 GB, and may be configured as a DDR3LM package or an LPDDR2 or LPDDR3 memory, which is soldered onto a motherboard via a ball grid array (BGA).

To provide for persistent storage of information such as data, applications, operating systems and so forth, a mass storage 1308 may also be coupled to the processor 1302 via the bus 1306. To enable a thinner and lighter system design, the mass storage 1308 may be implemented via a solid state drive (SSD). Other devices that may be used for the mass storage 1308 include flash memory cards, such as SD cards, microSD cards, xD picture cards, and the like, and USB flash drives.

In low power implementations, the mass storage 1308 may be on-die memory or registers associated with the processor 1302. However, in some examples, the mass storage 1308 may be implemented using a micro hard disk drive (HDD). Further, any number of new technologies may be used for the mass storage 1308 in addition to, or instead of, the technologies described, such resistance change memories, phase change memories, holographic memories, or chemical memories, among others. For example, the IoT device 1300 may incorporate the 3D XPOINT memories from Intel® and Micron®.

The components may communicate over the bus 1306. The bus 1306 may include any number of technologies, including industry standard architecture (ISA), extended ISA (EISA), peripheral component interconnect (PCI), peripheral component interconnect extended (PCIx), PCI express (PCIe), or any number of other technologies. The bus 1306 may be a proprietary bus, for example, used in a SoC based system. Other bus systems may be included, such as an I²C interface, I³C interface, an SPI interface, point to point interfaces, and a power bus, among others.

The bus 1306 may couple the processor 1302 to a mesh transceiver 1310, for communications with other mesh devices 1312. The mesh transceiver 1310 may use any number of frequencies and protocols, such as 2.4 gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1312. For example, a WLAN unit may be used to implement WiFi™ communications in accordance with the Institute of Electrical and Electronics Engineers (IEEE) 802.11 standard. In addition, wireless wide area communications, e.g., according to a cellular or other wireless wide area protocol, can occur via a WWAN unit.

The mesh transceiver 1310 may communicate using multiple standards or radios for communications at different range. For example, the IoT device 1300 may communicate with geographically proximate devices, e.g., within about 10 meters, using a local transceiver based on BLE, or another low power radio, to save power. More distant mesh devices 1312, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee. The mesh transceiver 1310 may be incorporated into an MCU as an address directly accessible by the chip, such as in the Curie® units available from Intel.

An uplink transceiver 1314 may be included to communicate with devices in the cloud 302. The uplink transceiver 1314 may be LPWA transceiver that follows the IEEE 802.15.4, IEEE 802.15.4g, IEEE 802.15.4e, IEEE 802.15.4k, or NB-IoT standards, among others. The IoT device 1300 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, Weightless-P from the Weightless Special Interest Group, Random Phase Multiple Access (RPMA®) from Ingenu, and other technologies. Further, other communications techniques, such as time-slotted channel hopping, described in the IEEE 802.15.4e specification may be used.

Any number of other radio communications and protocols may be used in addition to the systems mentioned for the mesh transceiver 1310 and uplink transceiver 1314, as described herein. For example, the radio transceivers 1310 and 1312 may include an LTE or other cellular transceiver that uses spread spectrum (SPA/SAS) communications for implementing high-speed communications, such as for video transfers. Further, any number of other protocols may be used, such as Wi-Fi® networks for medium speed communications, such as still pictures, sensor readings, and provision of network communications.

The radio transceivers 1310 and 1312 may include radios that are compatible with any number of 3GPP (Third Generation Partnership Project) specifications, notably Long Term Evolution (LTE), Long Term Evolution-Advanced (LTE-A), Long Term Evolution-Advanced Pro (LTE-A Pro), or Narrow Band IoT (NB-IoT), among others. It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology. Other Third Generation Partnership Project (3GPP) radio communication technology that may be used includes UMTS (Universal Mobile Telecommunications System), FOMA (Freedom of Multimedia Access), 3GPP LTE (Long Term Evolution), 3GPP LTE Advanced (Long Term Evolution Advanced), 3GPP LTE Advanced Pro (Long Term Evolution Advanced Pro)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High-speed Packet Access), HSDPA (High-Speed Downlink Packet Access), HSUPA (High-Speed Uplink Packet Access), HSPA+(High-speed Packet Access Plus), UMTS-TDD (Universal Mobile Telecommunications System-Time-Division Duplex), TD-CDMA (Time Division-Code Division Multiple Access), TD-SCDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP LTE Extra, LTE Licensed-Assisted Access (LAA), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Wireless Gigabit Alliance (WiGig) standard, mmWave standards in general (wireless systems operating at 10-90 GHz and above such as WiGig, IEEE 802.11ad, IEEE 802.11ay, and the like. In addition to the standards listed above, any number of satellite uplink technologies may be used for the uplink transceiver 1314, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1316 may be included to provide a wired communication to the cloud 302 or to other devices, such as the mesh devices 1312. The wired communication may provide an Ethernet connection, or may be based on other types of networks, such as Controller Area Network (CAN), Local Interconnect Network (LIN), DeviceNet, ControlNet, Data Highway+, EtherCAT, SERCOS, PROFIBUS, PROFINET RT, or PROFINET IRT, among many others. An additional NIC 1316 may be included to allow connection to a second network, for example, a NIC 1316 providing communications to the cloud over Ethernet, and a second NIC 1316 providing communications to other devices over another type of network.

The bus 1306 may couple the processor 1302 to an interface 1318 that is used to connect external devices. The external devices may include sensors 1320, such as accelerometers, level sensors, flow sensors, temperature sensors, pressure sensors, barometric pressure sensors, and the like. The interface 1318 may be used to connect the IoT device 1300 to actuators 1322, such as power switches, valve actuators, an audible sound generator, a visual warning device, and the like.

While not shown, various input/output (I/O) devices may be present within, or connected to, the IoT device 1300. For example, a display may be included to show information, such as sensor readings or actuator position. An input device, such as a touch screen or keypad may be included to accept input.

A battery 1324 may power the IoT device 1300, although in examples in which the IoT device 1300 is mounted in a fixed location, it may have a power supply coupled to an electrical grid. The battery 1324 may be a lithium ion battery, a metal-air battery, such as a zinc-air battery, an aluminum-air battery, a lithium-air battery, a hybrid super-capacitor, and the like.

A battery monitor/charger 1326 may be included in the IoT device 1300 to track the state of charge (SoCh) of the battery 1320. The battery monitor/charger 1326 may be used to monitor other parameters of the battery 1324 to provide failure predictions, such as the state of health (SoH) and the state of function (SoF) of the battery 1324. The battery monitor/charger 1326 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1326 may communicate the information on the battery 1324 to the processor 1302 over the bus 1306. The battery monitor/charger 1326 may also include an analog-to-digital (ADC) convertor that allows the processor 1302 to directly monitor the voltage of the battery 1326 or the current flow from the battery 1324. The battery parameters may be used to determine actions that the IoT device 1300 may perform, such as transmission frequency, mesh network operation, sensing frequency, and the like.

A power block 1328, or other power supply coupled to a grid, may be coupled with the battery monitor/charger 1326 to charge the battery 1324. In some examples, the power block 1328 may be replaced with a wireless power receiver to obtain the power wirelessly, for example, through a loop antenna in the IoT device 1300. A wireless battery charging circuit, such as an LTC4020 chip from Linear Technologies of Milpitas, Calif., among others, may be included in the battery monitor/charger 1326. The specific charging circuits chosen depend on the size of the battery 1324, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others. In some examples, the power block 1328 may be augmented or replaced with solar panels, a wind generator, a water generator, or other natural power systems.

The mass storage 1308 may include a number of modules to implement one or more of IoT device addressing, alias/shortcode addressing, alias-based time-limited addressing, lease addressing, mapping, translation, or any other techniques described herein. Although shown as code blocks in the mass storage 1308, it may be understood that any of the modules may be fully or partially replaced with hardwired circuits, for example, built into an application specific integrated circuit (ASIC). The mass storage 1308 may include alias/shortcode addressing 1330 according to some embodiments. Addressing 1330 can include code to implement any of the techniques described herein. In some embodiments, IoT device 1300 can include a system or a subsystem to implement any of the techniques described herein. For example, in some embodiments, IoT device can be or can include a system or subsystem such as time-limited alias addressing subsystem 580 of FIG. 5.

Examples and embodiments of various techniques have been illustrated and described herein as being implemented, for example, using a processor executing stored instructions. However, it is noted that other examples and embodiments of any of these techniques can includes other implementations. For example, any of the techniques illustrated or described herein can be implemented in any of hardware, software, firmware, or in any combination thereof. Some embodiments can be implemented, for example, using an Application Specific Integrated Circuit (ASIC) or a Field Programmable Gate Array (FPGA), among others.

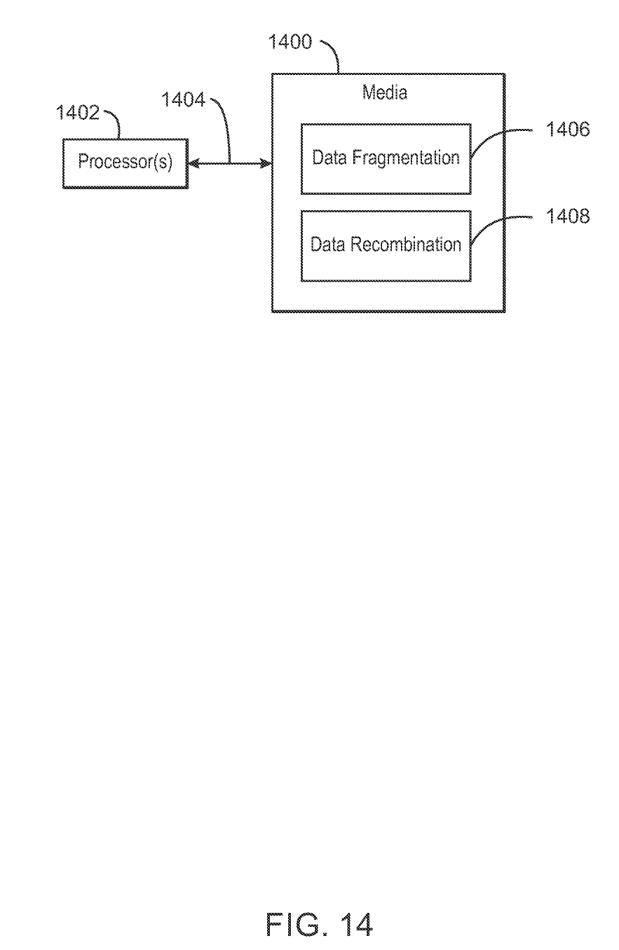

FIG. 14 is a block diagram of an exemplary non-transitory, media/medium 1400 (for example, one or more computer readable medium 1400 or one or more machine readable medium 1400) including code to direct one or more processor 1402 to implement data fragmentation and/or data recombination in accordance with some embodiments. The processor(s) 1402 may access the non-transitory, machine readable medium 1400 over a bus 1404. The processor(s) 1402 and bus 1404 may be selected as described with respect to the processor 1302 and bus 1306 of FIG. 13. The medium 1400 or media 1400 may include one or more devices described for the mass storage 1308 of FIG. 13 or may include optical disks, thumb drives, or any number of other hardware devices.

The media or medium 1400 may include code to direct the processor(s) 1402 to implement one or more of data fragmentation and/or data recombination, or any other techniques described herein. For example, in some embodiments, the media or medium 1400 may include code 1406 to direct the processor(s) 1402 to implement data fragmentation. In some embodiments, the media or medium 1400 may include code 1408 to direct the processor(s) 1402 to implement data recombination.

The techniques described herein may be used to implement any number of IoT networks for various purposes. Additional applications may be implemented.

Example 1 includes an Internet of Things (IoT) device to recombine data fragments of a data payload. The IoT device includes storage to store instructions and a processor to execute the stored instructions to receive the data fragments in order or out of order, to determine whether all data fragments of the data payload have been received, and if all data fragments of the data payload have been received, to store the data fragments in order.

Example 2 includes the subject matter of example 1. In example 2, the processor is to execute the stored instructions to determine if a received data fragment is the first received data fragment of the data payload, to create a partial object for the data payload if the received data fragment is the first received data fragment of the data payload, and to add the received data fragment to the partial object for the data payload if the received data fragment is not the first received data fragment of the data payload.

Example 3 includes the subject matter of any of examples 1-2. In example 3, the processor is to execute the stored instructions to determine if a received data fragment is the first received data fragment of the data payload, and to create a time to live timer if the received data fragment is the first received data fragment of the data payload.

Example 4 includes the subject matter of any of examples 1-3. In example 4, the processor is to execute the stored instructions to determine if a time of the time to live timer has expired, to determine if all data fragments have been received, and to identify that receipt of the data payload is a failure if the time of the time to live timer has expired and all data fragments have not been received.

Example 5 includes the subject matter of any of examples 1-4. In example 5, the processor is to execute the stored instructions to request a re-transmission of one or more fragments of the data payload if the time of the time to live timer has expired.

Example 6 includes the subject matter of any of examples 1-5. In example 6, the processor is to execute the stored instructions to determine if a received data fragment is the first received data fragment of the data payload, and to add the received data fragment to an existing partial agent if the received data fragment is not the first received data fragment of the data payload.

Example 7 includes the subject matter of any of examples 1-6. In example 7, the processor is to execute the stored instructions to determine if all data fragments have been received, and to verify an integrity of the data payload if all data fragments of the data payload have been received.

Example 8 includes the subject matter of any of examples 1-7. In example 8, the processor is to execute the stored instructions to destroy a partial object agent after the data payload has been stored or after a failure in transmission of the data payload has been determined.

Example 9 includes a method of recombining received data fragments of a data payload in an Internet of Things (IoT) network. The method includes receiving the data fragments in order or out of order, determining whether all data fragments of the data payload have been received, and if all data fragments of the data payload have been received, storing the data fragments in order.

Example 10 includes the subject matter of example 9. In example 10, the method includes determining if a received data fragment is the first received data fragment of the data payload, creating a partial object for the data payload if the received data fragment is the first received data fragment of the data payload, and adding the received data fragment to the partial object for the data payload if the received data fragment is not the first received data fragment of the data payload.

Example 11 includes the subject matter of any of examples 9-10. In example 11, the method includes determining if a received data fragment is the first received data fragment of the data payload, and creating a time to live timer if the received data fragment is the first received data fragment of the data payload.

Example 12 includes the subject matter of any of examples 9-11. In example 12, the method includes determining if a time of the time to live timer has expired, determining if all data fragments have been received, and identifying that receipt of the data payload is a failure if the time of the time to live timer has expired and all data fragments have not been received.

Example 13 includes the subject matter of any of examples 9-12. In example 13, the method includes requesting a re-transmission of one or more fragments of the data payload if the time of the time to live timer has expired.

Example 14 includes the subject matter of any of examples 9-13. In example 14, the method includes determining if a received data fragment is the first received data fragment of the data payload, and adding the received data fragment to an existing partial agent if the received data fragment is not the first received data fragment of the data payload.

Example 15 includes the subject matter of any of examples 9-14. In example 15, the method includes verifying an integrity of the data payload if all data fragments of the data payload have been received.

Example 16 includes the subject matter of any of examples 9-15. In example 16, the method includes destroying a partial object agent after the data payload has been stored or after a failure in transmission of the data payload has been determined.

Example 17 includes an Internet of Things (IoT) system. The IoT system includes a first IoT device to fragment a data payload into data fragments and to transmit the data fragments, and a second IoT device to recombine the data fragments. The second IoT device includes storage to store instructions and a processor to execute the stored instructions to receive the data fragments in order or out of order, to determine whether all data fragments of the data payload have been received, and if all data fragments of the data payload have been received, store the data fragments in order.

Example 18 includes the subject matter of example 17. In example 18, the processor is to execute the stored instructions to determine if a received data fragment is the first received data fragment of the data payload, to create a partial object for the data payload if the received data fragment is the first received data fragment of the data payload, and to add the received data fragment to the partial object for the data payload if the received data fragment is not the first received data fragment of the data payload.

Example 19 includes the subject matter of any of examples 17-18. In example 19, the processor is to execute the stored instructions to determine if a received data fragment is the first received data fragment of the data payload, and to create a time to live timer if the received data fragment is the first received data fragment of the data payload.

Example 20 includes the subject matter of any of examples 17-19. In example 20, the processor is to execute the stored instructions to determine if a time of the time to live timer has expired, and to identify that receipt of the data payload is a failure if the time of the time to live timer has expired.

Example 21 includes the subject matter of any of examples 17-20. In example 21, the processor is to execute the stored instructions to request a re-transmission of one or more fragments of the data payload if the time of the time to live timer has expired.

Example 22 includes the subject matter of any of examples 17-21. In example 22, the processor is to execute the stored instructions to determine if a received data fragment is the first received data fragment of the data payload, and to add the received data fragment to an existing partial agent if the received data fragment is not the first received data fragment of the data payload.

Example 23 includes the subject matter of any of examples 17-22. In example 23, the processor is to execute the stored instructions to verify an integrity of the data payload if all data fragments of the data payload have been received.

Example 24 includes the subject matter of any of examples 17-23. In example 24, the processor is to execute the stored instructions to destroy a partial object agent after the data payload has been stored or after a failure in transmission of the data payload has been determined.

Example 25 includes a non-transitory computer readable medium to recombine data fragments of an Internet of Things (IoT) data payload. The computer readable medium includes instructions that, when executed, direct a processor to receive the data fragments in order or out of order, to determine whether all data fragments of the data payload have been received, and if all data fragments of the data payload have been received, store the data fragments in order.

Example 26 includes the subject matter of example 25. In example 26, the computer readable medium includes instructions that, when executed, direct a processor to determine if a received data fragment is the first received data fragment of the data payload, to create a partial object for the data payload if the received data fragment is the first received data fragment of the data payload, and to add the received data fragment to the partial object for the data payload if the received data fragment is not the first received data fragment of the data payload.

Example 27 includes the subject matter of any of examples 25-26. In example 27, the computer readable medium includes instructions that, when executed, direct a processor to determine if a received data fragment is the first received data fragment of the data payload, and to create a time to live timer if the received data fragment is the first received data fragment of the data payload.

Example 28 includes the subject matter of any of examples 25-27. In example 28, the computer readable medium includes instructions that, when executed, direct a processor to determine if a time of the time to live timer has expired, and to identify that receipt of the data payload is a failure if the time of the time to live timer has expired.

Example 29 includes the subject matter of any of examples 25-28. In example 29, the computer readable medium includes instructions that, when executed, direct a processor to request a re-transmission of one or more fragments of the data payload if the time of the time to live timer has expired.

Example 30 includes the subject matter of any of examples 25-29. In example 30, the computer readable medium includes instructions that, when executed, direct a processor to determine if a received data fragment is the first received data fragment of the data payload, and to add the received data fragment to an existing partial agent if the received data fragment is not the first received data fragment of the data payload.

Example 31 includes the subject matter of any of examples 25-30. In example 31, the computer readable medium includes instructions that, when executed, direct a processor to verify an integrity of the data payload if all data fragments of the data payload have been received.

Example 32 includes the subject matter of any of examples 25-31. In example 32, the computer readable medium includes instructions that, when executed, direct a processor to destroy a partial object agent after the data payload has been stored or after a failure in transmission of the data payload has been determined.

Example 33 includes the subject matter of any of examples 1-8. In example 33, each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

Example 34 includes the subject matter of any of examples 1-8 or 33. In example 34, the processor is to execute the stored instructions to
determine if a received data fragment is a last received data fragment of the data payload; and
destroy a partial object for the data payload if the received data fragment is the last received data fragment of the data payload.

Example 35 includes the subject matter of any of examples 1-8, 33 or 34. In example 35, the processor is to execute the stored instructions to:
determine if a received data fragment is a last received data fragment of the data payload; and
destroy a time to live timer if the received data fragment is the last received data fragment of the data payload.

Example 36 includes the subject matter of any of examples 9-16. In example 36, each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

Example 37 includes the subject matter of any of examples 9-16 or 36. In example 37, the method includes determining if a received data fragment is a last received data fragment of the data payload, and destroying a partial object for the data payload if the received data fragment is the last received data fragment of the data payload.

Example 38 includes the subject matter of any of examples 9-16 or 36-37. In example 38, the method includes determining if a received data fragment is a last received data fragment of the data payload, and destroying a time to live timer if the received data fragment is the last received data fragment of the data payload.

Example 39 includes the subject matter of any of examples 9-16 or 36-38. In example 39, the method includes determining if a received data fragment is the first received data fragment of the data payload, and creating a time to live timer if the received data fragment is the first received data fragment of the data payload.

Example 40 includes the subject matter of any of examples 9-16 or 36-39. In example 40, the method includes requesting a re-transmission of one or more fragments of the data payload if the time of the time to live timer has expired.

Example 41 includes the subject matter of any of examples 17-24. In example 41, each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

Example 42 includes the subject matter of any of examples 17-24 or 41. In example 42, the processor is to execute the stored instructions to:
determine if a received data fragment is a last received data fragment of the data payload; and
destroy a partial object for the data payload if the received data fragment is the last received data fragment of the data payload.

Example 43 includes the subject matter of any of examples 17-24 or 41-42. In example 43, the processor is to execute the stored instructions to:
determine if a received data fragment is a last received data fragment of the data payload; and
destroy a time to live timer if the received data fragment is the last received data fragment of the data payload.

Example 44 includes the subject matter of any of examples 25-32. In example 44, each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

Example 45 includes the subject matter of any of examples 25-32 or 44. In example 45, the medium includes instructions that, when executed, direct a processor to determine if a received data fragment is a last received data fragment of the data payload, and to destroy a partial object for the data payload if the received data fragment is the last received data fragment of the data payload.

Example 46 includes the subject matter of any of examples 25-32 or 44-45. In example 46, the medium includes instructions that, when executed, direct a processor to determine if a received data fragment is a last received data fragment of the data payload, and to destroy a time to live timer if the received data fragment is the last received data fragment of the data payload.

Example 47 includes an Internet of Things (IoT) device to transmit data fragments of a data payload. The IoT device includes storage to store instructions, and a processor to execute the stored instructions to transmit the data fragments, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload, and to receive an indication as to whether all data fragments have been received by a second IoT device.

Example 48 includes the subject matter of example 47. In example 48, the processor is to execute the stored instructions to receive a request for re-transmission of one or more fragments of the data payload.

Example 49 includes the subject matter of any of examples 47-48. In example 49, the processor is to execute the stored instructions to dynamically adjust the number or size of the data fragments, and to transmit remaining data fragments based on the dynamic adjusting.

Example 50 includes an apparatus including means to perform a method as in any other example.

Example 51 includes machine-readable storage including machine-readable instructions, when executed, to implement a method or realize an apparatus as in any other example.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the techniques. The various appearances of “an embodiment”, “one embodiment”, or “some embodiments” are not necessarily all referring to the same embodiments. Elements or aspects from an embodiment can be combined with elements or aspects of another embodiment.

Not all components, features, structures, characteristics, etc. described and illustrated herein need to be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An Internet of Things (IoT) device to recombine data fragments of a data payload, comprising:
storage to store instructions; and
a processor to execute the stored instructions to:
receive the data fragments in order or out of order;
determine whether all data fragments of the data payload have been received; and
if all data fragments of the data payload have been received, store the data fragments in order.

2. The IoT device of claim 1, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

3. The IoT device of claim 1, wherein the processor is to execute the stored instructions to:
determine if a received data fragment is a last received data fragment of the data payload; and
destroy a partial object for the data payload if the received data fragment is the last received data fragment of the data payload.

4. The IoT device of claim 1, wherein the processor is to execute the stored instructions to:
determine if a received data fragment is a last received data fragment of the data payload; and
destroy a time to live timer if the received data fragment is the last received data fragment of the data payload.

5. The IoT device of claim 1, wherein the processor is to execute the stored instructions to:
determine if a received data fragment is the first received data fragment of the data payload;
create a partial object for the data payload if the received data fragment is the first received data fragment of the data payload; and
add the received data fragment to the partial object for the data payload if the received data fragment is not the first received data fragment of the data payload.

6. The IoT device of claim 1, wherein the processor is to execute the stored instructions to:
determine if a received data fragment is the first received data fragment of the data payload; and
create a time to live timer if the received data fragment is the first received data fragment of the data payload.

7. The IoT device of claim 6, wherein the processor is to execute the stored instructions to:
determine if a time of the time to live timer has expired;
determine if all data fragments have been received; and
identify that receipt of the data payload is a failure if the time of the time to live timer has expired and all data fragments have not been received.

8. The IoT device of claim 6, wherein the processor is to execute the stored instructions to:
request a re-transmission of one or more fragments of the data payload if the time of the time to live timer has expired.

9. The IoT device of claim 1, wherein the processor is to execute the stored instructions to:
determine if a received data fragment is the first received data fragment of the data payload; and
add the received data fragment to an existing partial agent if the received data fragment is not the first received data fragment of the data payload.

10. The IoT device of claim 1, wherein the processor is to execute the stored instructions to:
determine if all data fragments have been received; and
verify an integrity of the data payload if all data fragments of the data payload have been received.

11. The IoT device of claim 1, wherein the processor is to execute the stored instructions to:
destroy a partial object agent after the data payload has been stored or after a failure in transmission of the data payload has been determined.

12. A method of recombining received data fragments of a data payload in an Internet of Things (IoT) network, comprising:
receiving the data fragments in order or out of order;
determining whether all data fragments of the data payload have been received; and
if all data fragments of the data payload have been received, storing the data fragments in order.

13. The method of claim 12, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

14. The method of claim 12, comprising:
determining if a received data fragment is a last received data fragment of the data payload; and
destroying a partial object for the data payload if the received data fragment is the last received data fragment of the data payload.

15. The method of claim 12, comprising:
determining if a received data fragment is a last received data fragment of the data payload; and
destroying a time to live timer if the received data fragment is the last received data fragment of the data payload.

16. The method of claim 12, comprising:
determining if a received data fragment is the first received data fragment of the data payload;
creating a partial object for the data payload if the received data fragment is the first received data fragment of the data payload; and
adding the received data fragment to the partial object for the data payload if the received data fragment is not the first received data fragment of the data payload.

17. The method of claim 12, comprising:
determining if a received data fragment is the first received data fragment of the data payload; and
creating a time to live timer if the received data fragment is the first received data fragment of the data payload.

18. The method of claim 17, comprising:
requesting a re-transmission of one or more fragments of the data payload if the time of the time to live timer has expired.

19. The method of claim 17, comprising:
determining if a time of the time to live timer has expired;
determining if all data fragments have been received; and
identifying that receipt of the data payload is a failure if the time of the time to live timer has expired and all data fragments have not been received.

20. The method of claim 12, comprising:
determining if a received data fragment is the first received data fragment of the data payload; and
adding the received data fragment to an existing partial agent if the received data fragment is not the first received data fragment of the data payload.

21. An Internet of Things (IoT) system comprising:
a first IoT device to fragment a data payload into data fragments and to transmit the data fragments; and
a second IoT device to recombine the data fragments, the second IoT device including:
storage to store instructions; and
a processor to execute the stored instructions to:
receive the data fragments in order or out of order;
determine whether all data fragments of the data payload have been received; and
if all data fragments of the data payload have been received, store the data fragments in order.

22. The IoT system of claim 21, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

23. The IoT system of claim 21, wherein the processor is to execute the stored instructions to:
determine if a received data fragment is a last received data fragment of the data payload; and
destroy a partial object for the data payload if the received data fragment is the last received data fragment of the data payload.

24. The IoT system of claim 21, wherein the processor is to execute the stored instructions to:
determine if a received data fragment is a last received data fragment of the data payload; and
destroy a time to live timer if the received data fragment is the last received data fragment of the data payload.

25. The IoT system of claim 21, wherein the processor is to execute the stored instructions to:
determine if a received data fragment is the first received data fragment of the data payload;
create a partial object for the data payload if the received data fragment is the first received data fragment of the data payload; and
add the received data fragment to the partial object for the data payload if the received data fragment is not the first received data fragment of the data payload.

26. The IoT system of claim 21, wherein the processor is to execute the stored instructions to:
determine if a received data fragment is the first received data fragment of the data payload; and
create a time to live timer if the received data fragment is the first received data fragment of the data payload.

27. The IoT system of claim 21, wherein the processor is to execute the stored instructions to:
determine if a time of the time to live timer has expired; and
identify that receipt of the data payload is a failure if the time of the time to live timer has expired.

28. The IoT system of claim 21, wherein the processor is to execute the stored instructions to:
determine if a received data fragment is the first received data fragment of the data payload; and
add the received data fragment to an existing partial agent if the received data fragment is not the first received data fragment of the data payload.

29. A non-transitory computer readable medium to recombine data fragments of an Internet of Things (IoT) data payload, comprising instructions that, when executed, direct a processor to:
receive the data fragments in order or out of order;
determine whether all data fragments of the data payload have been received; and
if all data fragments of the data payload have been received, store the data fragments in order.

30. The non-transitory computer readable medium of claim 29, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload.

31. The non-transitory computer readable medium of claim 29, comprising instructions that, when executed, direct a processor to:
determine if a received data fragment is a last received data fragment of the data payload; and
destroy a partial object for the data payload if the received data fragment is the last received data fragment of the data payload.

32. The non-transitory computer readable medium of claim 29, comprising instructions that, when executed, direct a processor to:
determine if a received data fragment is a last received data fragment of the data payload; and
destroy a time to live timer if the received data fragment is the last received data fragment of the data payload.

33. The non-transitory computer readable medium of claim 29, comprising instructions that, when executed, direct a processor to:
determine if a received data fragment is the first received data fragment of the data payload;
create a partial object for the data payload if the received data fragment is the first received data fragment of the data payload; and
add the received data fragment to the partial object for the data payload if the received data fragment is not the first received data fragment of the data payload.

34. The non-transitory computer readable medium of claim 29, comprising instructions that, when executed, direct a processor to:
determine if a received data fragment is the first received data fragment of the data payload; and
create a time to live timer if the received data fragment is the first received data fragment of the data payload.

35. The non-transitory computer readable medium of claim 29, comprising instructions that, when executed, direct a processor to:
determine if a time of the time to live timer has expired; and
identify that receipt of the data payload is a failure if the time of the time to live timer has expired.

36. The non-transitory computer readable medium of claim 35, comprising instructions that, when executed, direct a processor to:
request a re-transmission of one or more fragments of the data payload if the time of the time to live timer has expired.

37. The non-transitory computer readable medium of claim 29, comprising instructions that, when executed, direct a processor to:
determine if a received data fragment is the first received data fragment of the data payload; and
add the received data fragment to an existing partial agent if the received data fragment is not the first received data fragment of the data payload.

38. The non-transitory computer readable medium of claim 29, comprising instructions that, when executed, direct a processor to:
verify an integrity of the data payload if all data fragments of the data payload have been received.

39. The non-transitory computer readable medium of claim 29, comprising instructions that, when executed, direct a processor to:
destroy a partial object agent after the data payload has been stored or after a failure in transmission of the data payload has been determined.

40. An Internet of Things (IoT) device to transmit data fragments of a data payload, comprising:
storage to store instructions; and
a processor to execute the stored instructions to:
transmit the data fragments, wherein each data fragment includes an indicator of the data type of the data payload, a unique identifier of an originating device of the data payload, a unique identifier of the data payload, a unique identifier of the data fragment, a timestamp of a recording of the data payload, and a number of data fragments of the data payload;
receive an indication as to whether all data fragments have been received by a second IoT device.

41. The IoT device of claim 40, the processor to execute the stored instructions to:
receive a request for re-transmission of one or more fragments of the data payload.

42. The IoT device of claim 40, the processor to execute the stored instructions to:
dynamically adjust the number or size of the data fragments; and
transmit remaining data fragments based on the dynamic adjusting.
